(19) United States
(12) Patent Application Publication
(10) Pub. No.: US 2005/0091346 A1
(43) Pub. Date: Apr. 28, 2005

(54) Settings management infrastructure

(76) Inventors: Brijesh Krishnaswami, Bellevue, WA (US); Anil Francis Thomas, Sammamish, WA (US); Avronil Bhattacharjee, Redmond, WA (US); Gregory Irving Thiel, Black Diamond, WA (US); John Charles Delo, Bellevue, WA (US); Kanwaljit Singh Marok, Sammamish, WA (US); Santanu Chakraboty, Bellevue, WA (US); Justin Yoo Kwak, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/693,019

(22) Filed: Oct. 23, 2003

(51) Int. Cl. G06F 15/173; G06F 9/46

(52) U.S. Cl. 709/220; 719/310

(57) ABSTRACT

The present invention provides for a system and method facilitating configuration management. The system includes a configuration store that stores persisted configuration and/or dependency information associated with application(s), and, a configuration service component that manages access to the configuration store. The system can further include a configuration management engine (e.g., API) that allows client application(s) to access, query and/or modify setting(s). In accordance with an aspect of the present invention, application(s) submit an XML assembly manifest which comprises: the assembly identity, the application binaries, its dependencies etc. The manifest can also include a configuration section that declaratively specifies the persisted settings for the application. The configuration section includes an XSD-based schema that defines rich types for the settings and the settings themselves, and metadata for these settings including description and default values, manageability attributes (e.g., migrate, backup, policy), and integrity constraints called assertions (that could potentially describe the relationships between settings).

### TECHNICAL FIELD

The present invention relates generally to computer configuration setting(s), and, more particularly, to a system and method facilitating management of configuration setting(s).

### BACKGROUND OF THE INVENTION

Management of application(s) and/or operating system service(s) can be quite cumbersome: it is difficult to install, update, or control their behavior reliably, for example, due to an incomplete understanding of the software's configuration and various dependencies. This presents numerous challenges to administrator(s) and user(s) who want to enforce a desired set of configurations for their applications and continue to maintain these settings in the face of everyday changes in the software lifecycle (e.g., Install, Usage, Servicing, Migration, Uninstall, amongst others.

Many conventional operating systems employ a registry that facilitates storage of information, for example, configuration information. Registry(ies) can serve as an information store for the operating system and for application(s) and service(s) running under the operating system. In one example, the registry stores a wide range of configuration settings ranging from boot parameters to user desktop settings. The registry can be stored as one or more configuration files stored on the storage system of a computer (e.g., persistent and/or non-persistent).

Application(s) can write (e.g., store) information in the registry upon installation. The registry is a hierarchically structured data store comprising subtrees of keys that reference per-computer and/or per-user data stores. A key can include data item(s) called value entries and can further include subkeys. In the registry structure, keys (and subkeys) can be thought of as analogous to directories with value entries being analogous to files. For example, the system registry can change on restart, logon and logoff.

With ever increasing advances in operating system technology, simultaneously permitting both legacy and native applications to coexist has been a daunting task for the operating system, and more specifically, the system registry. For example, different versions of an application can store their configuration information in a common configuration data structure. In fact, different versions of an application typically store their configuration information at a same location within a common configuration data structure. Thus, a later installed version can overwrite existing configuration information for an earlier installed version. As a result, the earlier version is unlikely to run correctly (or at all) because its configuration information has been changed. Sometimes residual configuration exists in the common configuration data structure that can interfere with smooth performance of the later installed version.

While conventional “manageability services” exist to assist owners in providing a more comprehensible and robust change control mechanism, they suffer from the fundamental limitation of inadequately grasping the application's real state, and the rules that advertise its state to other components. In many cases, manageability services employ rough heuristics to discover and make changes, and these may often prove to be fragile (and sometimes fatal) to one or more running components. For example, the installation of one component may change the configuration of another, thereby causing a potentially disastrous and irreversible alteration of the affected component's state. Similarly, settings saved to “non-standard” locations will be missed by the heuristics used by some manageability services, which typically traverse the user hives in the registry.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for a system and method facilitating configuration management. The system includes a configuration store that stores persisted configuration and/or dependency information associated with application(s), and, a configuration service component that manages access to the configuration store. The system can further include a configuration management engine (e.g., API) that allows client application(s) to access, query and/or modify setting(s).

Aspects of an infrastructure of the present invention facilitate discoverability of an application's settings and configuration data. Accordingly, management service(s) can readily exact change control on the application. The infrastructure further provides semantics that facilitate organization of configuration settings in a rational and comprehensible manner: when iterating through an application's settings, their intended meaning and the consequences associated with changing them can be easily understood.

The infrastructure further facilitates isolation of configuration settings and/or dependency(ies). For example, similarly named products and side-by-side installations of the same product do not interfere with each other's settings. Each individual application instance has an associated unique identifier that it uses to gain access to its settings.

In accordance with an aspect of the present invention, modifications to settings are thoroughly logged, to the extent that change information is recordable, and the changes themselves are revertible. Further, the infrastructure of the present invention can facilitate uniformity of access through a consistent programmatic interface that abstracts the storage implementation. Thus, in one example, settings can be accessed using a homogeneous API set, independent of the stores in which they reside.

Yet another aspect of the present invention provides for changes to settings values to be validated against constraints installed by application developers and/or administrators. In one example, there is no allowed mechanism for bypassing these constraints.

In accordance with an aspect of the present invention, application(s) submit an XML assembly manifest which comprises: the assembly identity, the application binaries, its dependencies etc. The manifest can also include a configuration section that declaratively specifies the persisted settings for the application. The configuration section includes an XSD-based schema that defines rich types for the settings and the settings themselves, and metadata for these settings including description and default values, manageability attributes (e.g., migrate, backup, policy), and integrity constraints called assertions (that could potentially describe the relationships between settings).

When an application is installed, the manifest is registered with the system. The configuration service component compiles the configuration section of the manifest into a namespace in its store. The namespace has a unique identity that matches the assembly identity. In one example, a Deployment ID can further uniquely identify the store as a same assembly can be installed multiple times on a system

Application(s) can access a given namespace's settings via the configuration management engine API. For example, the engine can support both managed and unmanaged API. Management service(s) can discover and/or query for settings via the engine as well (e.g., roaming service queries for settings that are roamable). The API can thus present a virtual XML view of the namespace to the client—settings, metadata and transaction records can be accessed via XPath queries. The API can further facilitate navigation down a hierarchical tree associated with the settings etc.

In this example, the API works on a transacted, isolated model. Application(s) open a namespace, read/write settings in a local cache, read committed, and save the namespace. Upon save, assertions in the namespace are evaluated for integrity—the save fails if one or more assertions are not satisfied. For example, the check(s) can be performed in a secure environment (e.g., service) The API can support change notification(s). Applications can listen to such notifications to be aware of external setting changes and respond to them (e.g., application of Group Policy changes to settings).

The configuration service component manages access to the configuration store. The configuration service component can serialize and processes request(s) to open and save namespaces to the service via local RPC calls. The service can also manage store compaction and/or performs assertion evaluation.

In another example, .Net application(s) can use a ApplicationSettingsBase class which offers method(s) to retrieve setting(s) (e.g., Load( )) and/or commit change(s) (e.g., Save( )) to the persisted configuration store.

Optionally, the system can support settings to be bound to legacy locations such as the registry, INI files and/or custom stores (e.g., WMI repository, IIS meta base store). Applications can specify legacy locations for settings in the manifest, and a handler to access these settings. This can allow applications whose settings reside in legacy stores (e.g., for interoperability and backward compatibility reasons) to describe and isolate their settings via the system. Such applications can continue to access their settings via legacy API. This enables management service(s) to discover their settings via the system. The system can support inbuilt handlers for the registry and INI files, and a COM-based provider model for custom handlers.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a configuration management system in accordance with an aspect of the present invention.

FIG. 2 is a block diagram of a system architecture in accordance with an aspect of the present invention.

FIG. 3 is a block diagram of a configuration management architecture in accordance with an aspect of the present invention.

FIG. 4 is a block diagram of a configuration management system architecture in accordance with an aspect of the present invention.

FIG. 5 is a block diagram of a Virtual Document Layer representation in accordance with an aspect of the present invention.

FIG. 6 is a block diagram of a configuration management system architecture in accordance with an aspect of the present invention.

FIG. 7 is a block diagram of a configuration management system architecture in accordance with an aspect of the present invention.

FIG. 8 is a diagram of an exemplary graphic user interface tool in accordance with an aspect of the present invention.

FIG. 9 is a flow chart of a method facilitating configuration management in accordance with an aspect of the present invention.

FIG. 10 is a flow chart of a method facilitating configuration management in accordance with an aspect of the present invention.

FIG. 11 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “computer component” is intended to refer to a computer-related entity, either hardware, a combination of hardware and software, software, or software in execution. For example, a computer component may be, but is not limited to being, a process running on a processor, a processor, an object, an executable, a thread of execution, a program, and/or a computer. By way of illustration, both an application running on a server and the server can be a computer component. One or more computer components may reside within a process and/or thread of execution and a component may be localized on one computer and/or distributed between two or more computers. Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

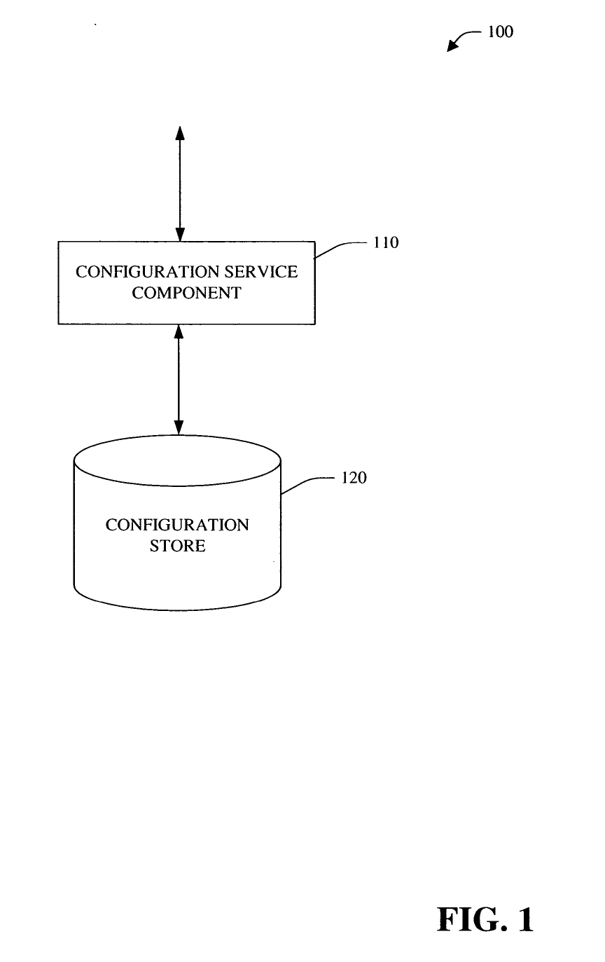

Referring to FIG. 1, a configuration management system 100 in accordance with an aspect of the present invention is illustrated. The system 100 includes a configuration service component 110 and a configuration store 120.

As discussed previously, conventionally, management of application(s) and/or operating system service(s) has been cumbersome: it has been difficult to install, update, and/or control their behavior reliably, for example, due to an incomplete understanding of the software's configuration and various dependencies. This has presented numerous challenges to administrator(s) and user(s) who wanted to enforce a desired set of configurations for their applications and continue to maintain these settings in the face of everyday changes in the software lifecycle, such as Install, Usage, Servicing, Migration, Uninstall, amongst others.

Conventional system(s) suffer from the fundamental limitation of inadequately grasping the application's real state, and the rules that advertise its state to other component(s). In many cases, management service(s) 260 employ rough heuristics to discover and make changes, and these may often prove to be fragile (and sometimes fatal) to one or more running components. For example, the installation of one component may change the configuration of another, thereby causing a potentially disastrous and irreversible alteration of the affected component's state. Similarly, settings saved to “non-standard” locations will be missed by the heuristics used by some management service(s) 260, such as Migration or Roaming, which typically traverse the user hives in the registry.

In accordance with an aspect of the present invention, the system 100 facilitates a well-described and robust substrate of machine and application configuration that can be used to reliably deliver richer management service(s) 260. For example, Roaming, Migration, Setup, Provisioning, Policy and/or Backup/Restore can be built far more efficiently and accurately on the intelligent configuration infrastructure of the present invention.

The system 100 thus evolves away from conventional configuration management system(s)' fragile way of manipulating their settings, stored in private formats, without knowledge of their semantics or a complete view of their intended use; alternatively, applications advance into a well-defined configuration description model (“settings configuration model”), where the relevant semantics are declaratively articulated; additionally, constraints and preferences from various entities, such as users, administrators, external applications, and management service(s) 260 can be reasonably expressed, reconciled, and enforced by the system in a safe way.

Thus, the system 100 facilitates employment of a declarative configuration schema, discussed more fully below, for application(s) to express their state, and/or configuration item(s), and the dependencies and/or constraints on them. For example, the schema can be XML-based. Applications are expected to provide a “manifest” based, at least in part, upon this schema which is their “canonical description document” for all of their configuration and dependencies.

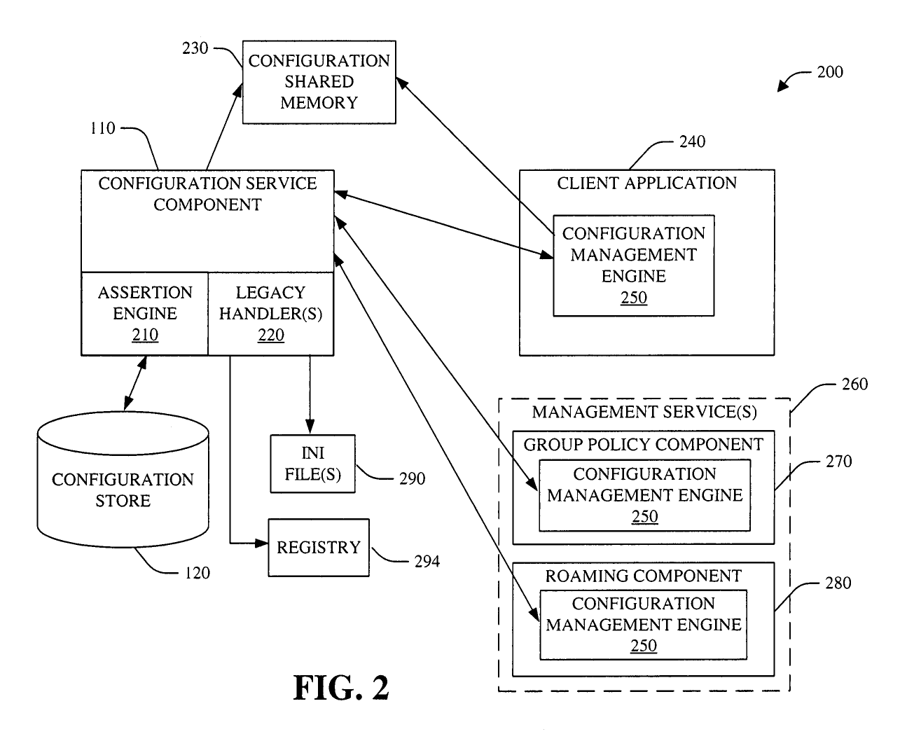

Referring briefly to FIG. 2, a system architecture 200 can, optionally, further include an assertion engine 210, legacy handler(s) 220, configuration shared memory 230, a client application 240, a configuration management engine 250, management service(s) 260, a group policy component 270, a roaming component 280, INI file(s) 290 and/or a registry 294.

The configuration management engine 250, described more fully below, can be built into the component, provides application(s) and/or manageability service(s) efficient and comprehensive APIs to query for, read from, and write to settings in a manageable way; modifications enable tracing, provide security, and enforce integrity rules defined in the target configuration manifest. Management service(s) 260, such as Roaming, Backup, Policy, etc., can use the configuration management engine 250 to discover an application's settings, and then manipulate the settings in a way consistent with their declared service semantics in the manifest.

The configuration store 120 stores the managed setting(s) of application(s) and, optionally, their history of changes. The configuration store 120 (e.g., database-based) can, for example, allow for efficient storage, queries, transactions, and/or role-based security support. These feature(s) can be available for use without further code investments on the part of application developers, many of whom require such functionality of their storage services. Optionally, synchronizing settings with external stores, such as the registry 294, can also be supported to maintain backward compatibility.

Thus, the system 100 mitigates the proliferation of obscure private settings, along with their proprietary schemas, esoteric stores, and custom API's , which require special-casing for the management of applications by every existing and future service. Thus the system 100 is geared towards providing a general-purpose, simple, consistent and declarative method for describing and managing an entire system's state, with full respect for known dependencies and integrity rules specified by the application and/or the administrator.

Scenarios & Benefits

This section enumerates exemplary management service(s) 260 that are commonly used by administrators and/or end users in order to administer useful change control over their systems, and to enforce consistent and predictable behavior of their applications. Moreover, this section describes how the infrastructure of the present invention (e.g., employed within system 100) can facilitate these services. An application can participate and benefit from these management service(s) 260 through providing a standardized description of their configuration(s), encapsulated in the form of a manifest.

Furthermore, this section delineates benefits to the application developer; these benefits pertain to simpler code or more expressive power when choosing to employ the system 100, compared against the continual use of legacy stores like Registry 294 or INI configuration 290 file(s).

Manageability Scenarios

Several exemplary manageability scenarios are listed below, along with a description of how each of these can be used to improve user experiences in the Longhorn platform release. Employ management service(s) 260 (e.g. available via configuration management engine 270, 290) include, but are not limited to the following: Roaming, Migration, Policy, Install/Servicing, Provisioning, Backup/Restore, Configuration UI/Automation.

Roaming

“Roaming” is a popular service that allows user(s) to move between multiple machines (with similar set of application(s)), and to have their user configurations follow them automatically. For example, this service is used in many enterprise deployments and is increasingly interesting for consumers who move between multiple machines at home and/or at work. Similar services are available that offer users the ability to create portable profiles, and/or movable set preferences, that they can take on their PDA's.

Conventionally, roaming relies on heuristics to copy much of the “user hive” in the registry (HKCU) and the user's “My Documents” folder. This action typically moves very large amounts of data, much of which may not be desired by the user. Where timestamps do not exist for registry keys, substantially everything is bulk-copied without regard to change, leading to severe slowdown and inefficiency. Further, if an application stores its settings or documents in places other than the above typical locations, they are generally not roamed. Finally, since settings are bulk-copied, change(s) made on the target (destination) are overwritten and no merging is generally possible.

In accordance with an aspect of the present invention, for applications providing manifest(s) to the configuration service component 110, the configuration service component 110 can deliver to the roaming component 280 only those setting(s) that have changed since a last synchronization. The roaming component 280 can also pick a subset of application(s), instead of the entire hive (e.g., based on a user and/or administrator's selection(s)). This can yield data efficiency, for example, up to a factor of 100 times over bulk copying. Additionally, the manifest metadata can mark setting(s) that should not be roamed, such as machine-specific configuration(s), and the destination machine's manifest can enforce validation rule(s) on incoming change(s). Thus, for example, the system 100 can offer merging granularity down to the individual setting level.

Migration

“Migration” allows users to capture configuration and/or data file(s) for an application so that these can be applied on to another machine and/or during operating system upgrade(s). Migration can be an important service for enterprises and users that are deploying new machines, specifically those that want to manufacture their operating environments and preferences, such as connection and machine settings, across those machines.

Conventionally migration of applications can be a time consuming process, in which the Migration service author serially created a model for each component's settings and dependencies based on experimental observation. This model was then used to extract the relevant information and recreate it on user systems. For example, some migration services can only scale to an order of fifty to one hundred applications; they inevitably leave many users frustrated, or insecure about bringing in a new PC to replace their working box.

In accordance with yet another aspect of the present invention, application(s) providing manifest(s) to the configuration service component 110 can receive efficient migration support. The discovery and determination of what to migrate is driven by the manifest, and avoids the costly re-examination for each component. Similarly, if good design practices are followed, for example, settings that are paths are clearly identified, then Migration can easily re-map them to a different PC where, for example, drive letters are different. As discussed below, the transformation of settings and the rules on migrating them are also expressible in the application manifest by the developer.

Policy/Provisioning

Group Policy is a management tool for administrators to enforce reliable behavior on application(s) in their enterprise by creating template configurations and locking these down in the registry 294. Provisioning agents like “Configure Your Server Wizard” also allow administrators to make operational preferences via UI that are written to application configurations in the registry 294.

Conventionally, implementation of policy has been complex for application authors. The author identified key settings for policy control in an Administrative Template, referred to as an ADM file, and maintained a duplicate copy of such settings, one for the user and one for the administrator. The administrator then employed the ADM file to create a standard configuration set, which was written to the “admin” keys and had Access Control Lists (ACL's ) to prevent change. The application has to poll for these admin keys and use them to override user choices. Not only was extra overhead for both the application developer and the administrator, but the full set of application configurations cannot be controlled, as any key not exposed by the application in the special infrastructure cannot be easily controlled or locked down without crippling the application.

Provisioning agents can bestow valuable configuration upon the machine, such as promotion to a server; nevertheless, the accruement of subsequent modifications, due to application usage or upgrade, inevitably departs from the base configuration and can compromise the server's functionality. Locking down keys through the use of ACL's is not a viable option, as this can restrict the server's avail; additionally, conventionally there is no mechanism for expressing preference sets, such as the stipulation that the port must be between 80 and 85. Measuring distances from the base configuration, and reverting to a machine's prior state typically proves to be a difficult task.

With respect to the system 100 for an application providing the configuration service component 110 with its manifest, defining its configuration(s), dependency(ies) and/or validation rule(s), the system 100 can automatically provide policy and provisioning in a deterministic fashion. Administrative constraints can be added as restriction expression(s) that are superimposed over the basic validation rule(s) provided by the developer in the manifest. Value updates are only accepted if they fulfill administrative assertions—this avoids the need for separate policy keys or restriction via ACL's. Advanced scenarios for ranges, pattern and value based validations, and choosing from preferences are possible; assertions can be merged by the system 100 to find the acceptable superposition of operating values.

Install/Uninstall/XCOPY

“Install” and “Uninstall” often require a clear understanding of an application's configuration(s) and dependency(ies), in addition to the locations of its binaries. Installing an application often places dependencies on other components, and may constrain their values, which can for example break existing functionality. Complimentarily, “Uninstall” requires a clear understanding of such dependencies. The “XCOPY” of an application also requires a clear and simple model by which to copy substantially all related application settings, so that its behavior can be duplicated on the destination.

In accordance with an aspect of the present invention, an application with a well-designed manifest, registered with the configuration service component 110, that describes its settings and maps their intended dependencies can easily allow impact prediction. Such application(s) can also be easily configured at, or prior to, deployment with new default values. XCOPY deployment is enabled as the system exports a “current settings” file into the application folder periodically. This settings file, which contains a report of current settings values, can be copied with app binaries and subsequently imported by the destination system to restore the application configurations taken from the source machine.

Backup/Restore/Automation/Management UI

Many other management service(s) 260 also rely on the descriptive information provided by the application manifest of the present invention. “Backup/Restore” typically desire to identify and archive substantially all of an application's configurations in addition to its binaries.

Automation and Management UI (e.g., MMC and CMT) desire to expose the system behavior in a standardized way to administrative scripts or GUI. To do so, they need mechanisms for discovering and manipulating an application's settings without having intimate knowledge of the application itself. This is possible through the settings configuration model of the present invention, in which applications express their settings in the form of the well-known format that is the manifest.

Developer Benefits

In addition to the administrator and end-user benefits attained through enlisting in the aforementioned management service(s) 260, the application author can also realize advantages from using the settings configuration model, especially when compared with rolling out his/her own solution on a store, for example, the INI file(s) 290 and/or the registry 294. For example, application developers, without needing to write and maintain special-purpose code, can achieve some of the following benefits:

Integrity, Isolation, Scoping

Conventionally, values stored in the registry 294 and/or INI file(s) 290 have been without integrity rules and thereby open to corruption. Typically, code was written to verify or repair damaged and/or missing values at the time said values are read.

Special work has been required for registry keys to support proper isolation of applications. Isolation refers to multiple simultaneous installations of the same application not bound to the same settings pool. Settings stored with the system 100 are automatically isolated across installed instances and versions. The system 100 can also enforces strong-typing, and the integrity rules declared in the manifest.

Furthermore, scoping is easily accomplished, as through the system 100, a manifest author has the ability to specify various user contexts: examples of user contexts include the “per user” context, which specifies the current user context for any setting values; or the “shared” context, which dictates that settings values are shared by substantially all users of the component.

Support for Transactions, Security, Change History

Many applications often require elements of a more sophisticated configuration control, such as transactional updates, than are available through current settings storage constructs. Using registry 294 keys and/or INI file(s) 290 can require the developer to write more code for creating a database-based solution, one which provides transactional changes and role-based security. The system 100 infrastructure furnishes most of this power automatically, and alleviates the cost of the application developer implementing and managing his/her own private storage. The system 100 supports transacted commits for saving related changes together. Additionally, ACL-based security and role-based security can be provided at per-setting granularity. Many other benefits of the SQL based model, such as performing queries, change logs and history, etc., are also available for developers to leverage in designing their applications at no additional implementation cost.

Simplicity of Code

For .NET application developers, the system 100 of the present invention represents an opportunity to simplify their source code for configuration management. The ability to label settings objects, such as colors, fonts, or IP addresses, within their definitions as [configuration], and have these objects and corresponding labels serialized into the system 100 constructs can be of tremendous convenience. The results of this channel for developer-provided configuration is automatically and transparently persisted and strongly-typed settings, with the system 100 framework providing the storage, loading, verification, and isolation functionality, yielding shorter, cleaner, and more robust code than writing the equivalent functions for serialization, isolation, reading, and verification of settings from registry 294 keys or private stores.

System Architecture

This section provides information regarding an exemplary system architecture employed within the system 100. Those skilled in the art will recognize that the system architecture described herein is an example of a system architecture that can be employed with the present invention. It is to be appreciated that any type of system architecture suitable for carrying out the present invention can be employed and all such system architectures are intended to fall within the cope of the appended claims.

The infrastructure of the present invention addresses commercial configuration management weaknesses of conventional configuration management systems. Thus, in accordance with an aspect of the present invention, the current functionality present in the registry 294, settings configurations of the INI file(s) 29, and other private settings stores, can be extended and their limitations mitigated.

For example, the system 100 can facilitate:

Discoverability: An application's settings and configuration data can be located easily, for example, for management service(s) 260 attempting to exact change control on that application. Setting(s) can have one owner; the base provider of the setting(s) can be identified (e.g., strong ownership of setting(s)). In one example, only the owner of the setting(s) can remove the setting(s).

Semantics: For example, settings can be organized in a rational and comprehensible manner: when iterating through an application's settings, their intended meaning and the consequences associated with changing them can be understood.

Difference(s): In one example, default value(s) can be stored in order to return to original (e.g., factory settings), and, provide for a return to valid value(s).

Isolation: Similarly named products and side-by-side installations of the same product do not interfere with each other's settings. Each individual application instance has an associated unique identifier that it uses to gain access to its settings.

Tracking: Modifications to settings can be thoroughly logged, to the extent that change information is recordable, and the changes themselves are reversible.

Uniformity of Access: Applications can employ a consistent programmatic interface that abstracts the storage implementation; thus, settings can be accessed using a homogeneous API set, independent of the stores in which they reside.

Integrity: Changes to settings values can be validated against constraints installed by application developers and administrators. In one example there is no allowed mechanism for bypassing these constraints.

In the exemplary system architecture discussed herein, the following were employed:
A common, rich Schema was defined to express application settings and configurations, embedded in the form of a manifest. The schema is used for settings' type definitions and element declarations; it is a strongly-typed, pattern-matching language that allows a colorful description of settings with metadata (e.g., based on XSD and additional XML to describe the settings)
A Settings Management Engine (e.g., configuration management engine 250) is provided, which enables settings and metadata access, querying, change notification, and/or transactional operations.
A robust, managed and abstracted, state configuration store 120 is built, which acts as a container for settings schemas, current settings values, and/or the change history of the settings. For example, the configuration store 120 can be periodically synchronized with external and/or legacy stores (e.g., registry 294 and/or INI file(s) 290).
Developer and/or administrator defined constraints placed on the ranges of allowable values for settings can be enforced; these constraints, referred to herein as “Assertions”, can express the developers' intended use for the settings.
Live settings and configuration for operating system components and applications that define a manifest using the schema, consume settings through the engine, and respond to change notifications can be managed and/or maintained.

Model

Most conventional configuration management systems are comprised of the interactions between applications, settings stores, and external processes that are interested in those applications and their settings. The applications create the settings and make updates to them throughout the course of their lifetimes; the application's binaries, combined with its settings and data can be thought of as a complete and unique state for that application. The settings stores are the locations in which the applications retain their settings; typically, settings can be stored in files, databases of various breeds, metabases, or even in remote web locations. The external processes that are interested in a particular application's settings (not their own) are those whose tasks it is to manipulate that application's state and to exact change control over that application; these processes, or services, are specialized for a large variety of state manipulation, including auditing configuration changes for the application, migrating the application and its state across different machines, and even enforcing policy on that application.

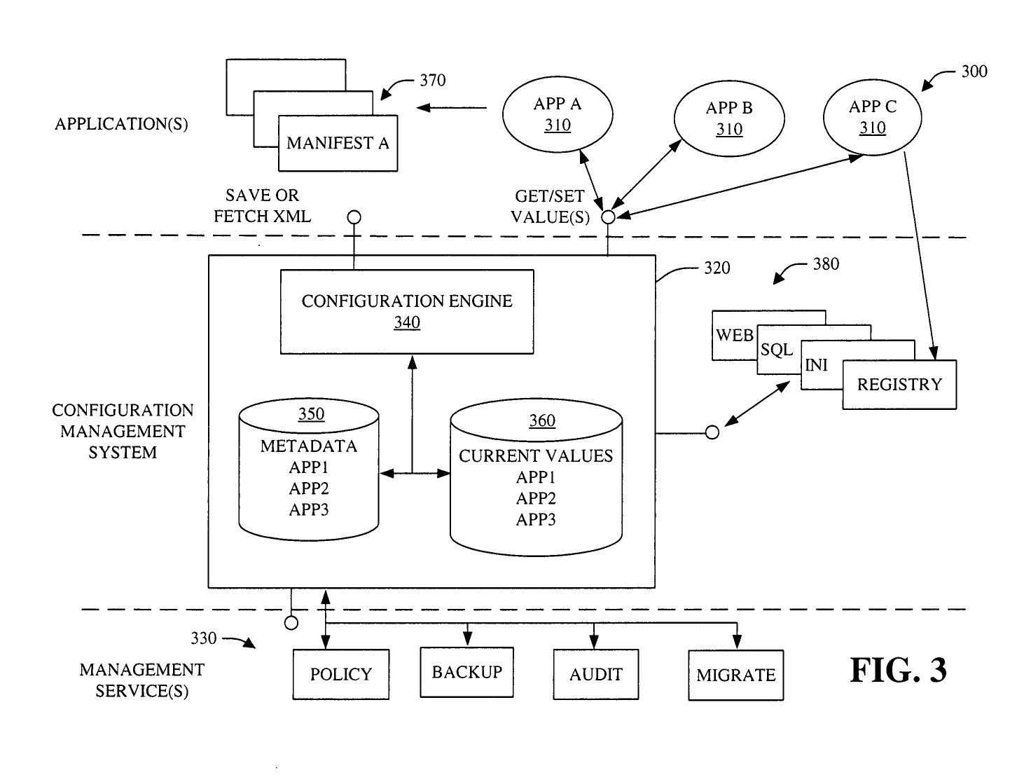

Referring to FIG. 3, exemplary configuration management architecture 300 in accordance with an aspect of the present invention is illustrated. The architecture 300 includes application(s) 310 that create settings, a configuration management system 320, and management service(s) 330 that consume those applications' settings. The configuration management system includes a configuration engine 340, a metadata store 350 and a current values store 360. The architecture 300 graphically depicts a conceptual model and illustrates the relationship of applications and management service(s) 260 with the configuration management system 320 infrastructure.

Application(s) 310, provide the configuration management system 320 with their manifest 370, which is the schematized description document of their settings and their constraints and dependencies. The configuration management system 320 then compiles and keeps this information in virtual “accounts” tied to each unique application. These accounts, strongly bound to the application identity, are referred to as the “namespace” for that application. Namespaces are uniquely distinguished by the application's assembly identity, specified in the manifest 370. This includes, for example, the name, version, language, Deploy ID, Process Architecture, and public key token of the application. Application(s) can access settings using URI which is a combination of namespace id and relative location root from the namespace, for example, to facilitate easy transfer reference to certain settings. The manifest 370 can specify whether the settings are directly stored with configuration management system 320, or if they are stored in legacy external store(s) 380 (e.g., the registry, INI file(s), SQL databases, etc.), for example, for backwards compatibility.

The configuration management system 320, compiles the manifest(s) 370 into runtime namespaces, manages access to the settings in the namespaces via the configuration management system 320 API (e.g., available via the configuration management engine 350), bi-directionally synchronizes the values of settings in its own store with parallel settings in legacy stores, and/or services query and set requests to application settings from manageability service(s) 330.

Management service(s) 330, for example, roaming, migration, etc., query the configuration management system 340 to retrieve subsets of settings for given namespaces based on query criteria; these services typically query the metadata residing on the setting, such as the “roam” or “migrate” attributes. Other manageability service(s) 330, such as Group Policy, apply valid settings changes to applications based on the specifications of the manifest 370.

Overview of Exemplary Architecture

Process Boundaries of Exemplary Architecture

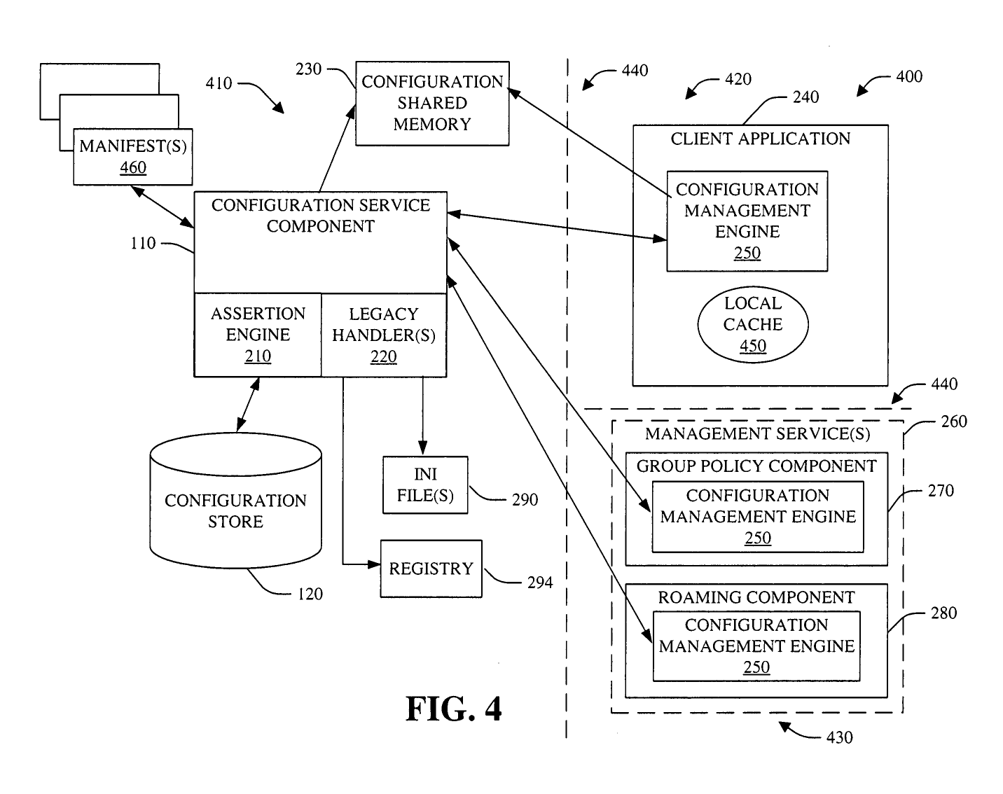

Turning to FIG. 4, a block diagram of a configuration management system architecture 400 in accordance with an aspect of the present invention is illustrated. The architecture 400 includes a configuration management system process region 410, a client application(s) process region 420 and management service(s) process region 430. FIG. 4 illustrates exemplary process boundaries of the system architecture 400. In the exemplary system architecture 400, process boundaries 440 designate the generic division of the set of architectural components into the three process regions 410, 420, 430.

With respect to the client application(s) process region 420, not all client application(s) reside within the same process; on the contrary, the intended implication is that within the context of a client application's interactions with the configuration service component 110, it crosses the process boundary 440 to load and save its settings into the configuration store 120, and, optionally to the legacy store(s) (e.g., registry 294 ).

The architecture 400 includes a configuration management engine 250 and an optional local cache 450 within the client application 240 as the client application 240 loads the configuration management engine 250 into its memory region at runtime, and can allocate the local cache 450 against which the engine 250 can perform fast operations.

A second region is the management service(s) process region 430, and depicts management service(s) 260 within an integral process region. Again, this is not to say that all of a system's management service(s) 260 exist within a single process; rather, the architecture 400's is to illustrate that the interactions between management service(s) 260 and the configuration service component 110 crosses the process boundary to load from and save to the settings namespaces of interest. The architecture 400 further illustrates a configuration management engine 250 within component(s) of the management service(s) 260. Similar to the client application(s) discussed previously, the management service(s) can load the configuration management engine 350, for example, as a library at runtime. In this example, the management service(s) 260 uses substantially the same machinations, as does the client application(s) for accessing settings namespaces.

The third and final of the resultant region of division by process boundaries 440 is the configuration management system process region 410. Within the boundaries of this process space 410 lie the configuration service component 110, the configuration store 120, the assertions engine 210, the legacy handler(s) 220, the configuration shared memory 230, the INI file(s) 290 and the registry 294. This is not intended to imply that all of these components are present within the memory region belonging to the configuration management system 100; alternatively, this is to suggest that the configuration management system 100 needs not cross the process boundary to access these resources.

Despite not being depicted in the architecture 400, a fourth process region exists, both relevant to the topic and appropriate within the context of this discussion: the Kernel process space. The Kernel-mode to User-mode division represents a much thicker and more impermeable process boundary than those depicted in FIG. 4, as it is very expensive for the Kernel to cross into User-mode, and the traversal carries much more consequential performance implications. Beyond the Kernel scenario, these requirements also apply to other scenarios in which crossing the process boundary is inconvenient or impossible, such as bootstrap applications that may come alive in the machine boot cycle before the services that enable inter-process communications.

The notion that client application(s) 240 and management service(s) 260 cross the process boundary in order to communicate with the configuration store 120 carries with it several inherited connotations. Among these connotations are the enforcements of integrity, security, and validation rules. Another ramification of settings configuration model described herein is the implicit concurrency control through the serialization of access to the settings store.

System Components

As stated in the discussion above and illustrated by FIG. 4, the configuration management system process region 410 has access (e.g., direct) to the compiled application manifest(s) 460, otherwise known as namespaces. The configuration service component 110 acquires these manifest(s) 460 from the application(s) 240 during the initial registration with configuration service component 110, and, followed by a one-time compilation process, provides access to these namespaces in the form of a Virtual Document.

The configuration management service 250 provides an interface into the Virtual Document: it is the API that application(s) use to access their settings and can use XPATH to access different parts of the virtual document. For example, the engine 350 can be implemented as a library that runs in the process of the calling application, in order to provide high performance. The API exposes a diverse variety of functionality to the client, including loading, saving and enumerating namespaces; consuming and enumerating settings values and metadata; querying; reverting transactions; creating and merging integrity constraints in the form of assertions; registering for change notifications; and even authoring entire settings namespaces. Permanent changes to the settings namespace propagated by the engine are serialized through the configuration service component 110.

The configuration management component 110 handles requests from client-side configuration management engine(s) 250 running within application(s) 240 and/or management service(s) 260. The configuration service component 110 acts as a gateway to the settings stores, serializing calls to load and save namespaces; upon receiving these requests, the configuration service component 110 accesses the appropriate settings stores to read from and write to those settings namespaces. Security and access restrictions can be enforced within the configuration service component 110; furthermore, the configuration service component 110 can host the assertion engine 210 as a means towards administering validation rules. The legacy handler(s) 220 can be employed to provide synchronization with legacy stores, for example, the registry 294 and/or INI file(s) 290. The configuration service component 110 can commit namespace changes to the configuration store 120 in a transactional manner.

The configuration store 120 can be, for example, an underlying joint engine technology database (JETDB) that stores the settings namespaces. A setting namespace comprises metadata on the settings, such as the types, attributes, and user context, as well as the instance values of the settings, stored for a user context. Database functionality is leveraged to expose transaction logging and recovery, and atomicity, when required. Those skilled in the art will recognize JETDB is an example of a data storage technique for storing information in the configuration store 120 that can be employed to protect the present invention. It is to be appreciated that any type of data storage technique suitable for carrying out the present invention can be employed and all such data storage technique(s) are intended to fall within the cope of the appended claims.

Backwards Compatibility and Legacy Storage

Optionally, application(s) 240 can also opt to maintain their settings within the storage constructs that they used conventionally. These constructs are referred to as legacy store(s) and can include for example, the registry 294, INI file(s) 290, databases, schematized files known as Metabases, and web abstractions of external stores, amongst other custom storage implementations. An application 240 can indicate a requirement for its settings, although managed by the configuration service component 110, to be stored in a legacy store, for reasons of compatibility, performance, and security; to do so, it simply populates a “legacy location” attribute that sits on the setting within the manifest 460, thereby pointing to the setting's “true” location. The advantage of advertising the setting to the configuration service component 110, even though its value is stored externally, is that the setting can be further described beyond its value with metadata, indicating default values, how the setting should be roamed or migrated, integrity constrains, etc. This “logical” representation of the setting in the configuration service component 110 provides discoverability, semantics, integrity, and tracking for the setting, all the while maintaining the advantages of performance, backwards compatibility, and proprietary security desired by the application developer.

For logical settings, any values set through the configuration service component 110 API are written through to the external stores. In order to interact with such stores, the configuration service component 110 uses a provider model, for example, employed through a COM object that implements a Get/Set interface for the external store; these are called store “handlers”, for example, legacy handler(s) 220. Developers can use these stores by simply specifying legacy locations in the manifest 460. For writing to other custom stores, the manifest author provides corresponding custom handlers that implement the public handler interface.

For external keys not accessed through the configuration service component 110 APIs, but through legacy interfaces, the infrastructure can only periodically monitor the settings changes being made, thereby providing partial notions of change history and integrity enforcement. Due to an incomplete control over these external stores, the effects of certain management service(s) 260, such as Group Policy enforcements, can naturally degrade in fidelity.

Isolation and Change Control Semantics

Modifications to settings values within a namespace are not realized until a commit operation is exacted on the namespace. When changes are committed to a namespace through a call to the Save method, transaction processing ensures the consistency and recoverability of the update. A transaction represents a basic unit of change to a settings namespace. If settings values were to be represented as a finite state machine, then the channels between states would represent transactions. Transactions can be rolled back, which has the effect of reverting the application to a prior state.

The aforementioned discussion of process regions mentions two memory caches: the local cache 450, allocated within the client application or manageability service process region, along with the configuration management engine 250; and a configuration shared memory 230, allocated by the configuration service component 110 into a shared memory region and/or read only cache. When an application first opens a namespace, the configuration management engine 250 triggers a load from the settings store into the configuration shared memory 230; the actual process of loading is carried out by the configuration service component 110. Subsequently, the client application(s) 240 instantiate settings and metadata objects in order to read from or make modifications to these constructs. Initially these objects will be pointing to the shared memory. Change(s) to these are stored in the local cache. In order to commit changes to the persisted configuration store 120, the client application 240 makes a call to the Save method, which sends the changes to the configuration service component 110; the modifications are consequently saved in the configuration store 120 after performing the assertion check(s). Following this operation, the configuration service component 110 then reconciles the new changes into the namespace view in configuration shared memory 230; change notifications are then sent to registered clients.

This model provides Read-Committed Isolation on the settings namespace: changes made in the namespace from one application are not visible to other applications until the application commits the changes. Additionally, the configuration management engine 250 supports a fully isolated mode of operation, in which the namespace settings are opened exclusively in process-local cache memory 450; a read-only copy is not maintained in the configuration shared memory 230. In this mode, no external changes are seen at all, even if other applications commit their changes; this provides a consistent view of the namespace amidst all external changes—however, since this mode is memory-intensive, as one copy of the namespace is required for every process that calls a Load operation, this mode is not encouraged for viewing large and common namespaces. In one example, by default, namespaces will be opened in the Read-Committed Isolation mode.

When a settings item within a namespace has been permanently changed through a commit operation, the configuration service component 110 sends notification(s) to substantially all applications registered to listen for changes to that particular setting. For example, notifications can contain a transaction id; which correlates the notification with the committed change that triggers it. The applications that are the recipients of the notification can use the configuration service component 110 API to enumerate the changes and see the old and new values. Applications whose settings are managed by the configuration service component 110 are encouraged to have a notification handler to process notifications; this handler can specify, for example, whether to accept or reject changes.

Component Architectures

The Manifest

The configuration manifest is the document that forms the representation (e.g., textual) of a component's settings and configurations; it is packaged as a part of the larger, more encompassing document that completely describes an application's state, known as the component manifest. In addition to the configuration manifest, the component manifest contains the application identity, security descriptors, installed files, folders, registry entries, and services, component dependencies, setup-specific custom commands, among other custom properties further describing the component.

The configuration manifest is organized into two subsections: the schema and metadata sections. In one example, the schema section encloses, in the form of an XML Schema Definitions Language (XSDL) document, the skeletal structure of the application's settings' type definitions and element declarations. The metadata section is an XML instance document, validated against the XSDL schema document, which serves to decorate the settings elements with attribute tags, as well as to provide more multifarious integrity constraints beyond the means of type bindings.

Within the schema section, the manifest author can define Simple Types, restrictions of the system's built-in scalar types; Complex Types, structures that can contain element content, are also defined within the schema section; finally, settings elements are declared in the schema section, and they are strongly bound to the antecedently defined types or the system's built-in types.

Beyond specifying the names of settings and the types to which they are bound, the system 100 infrastructure bestows the extensibility and dynamism of attaching various attributes to those settings. In the context of the metadata section, the configuration manifest allows details such as defaults, description, context, access control, validation, exposure to management service(s) 260, among other state-related information, to be anchored on settings, in order to better communicate the manifest author's intent in creating those settings.

The configuration manifest is received by the configuration service component 110, indexed by an assembly identity, another section of the component manifest, and compiled into a namespace; the configuration service component 110 stores and provides access to the namespaces for the components that provide configuration manifest(s).

The example component manifest set forth in Table I illustrates an embedded configuration manifest. The schema section in the example illustrates the definition of two types and the declaration of two settings; the metadata section demonstrates the designation of default values for those settings.

TABLE 1
<?xml version=″1.0″ ?>
<assembly xmlns:xsd=″http://www.w3.org/2001/XMLSchema″
xmlns:xsi=″http://www.w3.org/2001/XMLSchema-instance″
xmlns=″urn:schemas-microsoft-com:asm.v2″>

<!-- assemblyIdnetity - Used to specify the name and version info for the

assembly -->

<assemblyIdentity name = ″urn:sampleapp-schema″

version = ″1.0.0.0″
language = ″en-US″/>

<!-- configuration - Contains schema and metadata sections used by the

Settings management infrastructure configuration system-->

<configuration xmlns:xs =″http://www.w3.org/2001/XMLSchema″

xmlns:wcm=″http://schemas.microsoft.com/WMIConfig/2002/State″
xmlns:app=″urn:sampleapp-schema″ >

<configurationSchema>

<xsd:schema targetNamespace=″ urn:sampleapp-schema″

attributeFormDefault=″qualified″
elementFormDefault=″qualified″ >

<xsd:complexType name=″Point″>

<xsd:sequence>

<xsd:element name=″xcoord″ type=″xsd:integer″/>
<xsd:element name=″ycoord″ type=″xsd:integer″/>

</xsd:sequence>

</xsd:complexType>
<xsd:complexType name=″Window″>

<xsd:sequence>

<xsd:element name=″topleft″ type=″app:Point″/>
<xsd:element name=″bottomright″ type=″app:Point″/>

</xsd:sequence>

</xsd:complexType>
<xsd:element name=″mainwindow″ type=″app:Window″/>
<xsd:element name=″propertywindow″ type=″app:Window″/>

</xsd:schema>

</configurationSchema>

<!-- Metadata Additional data not contained within the schema to be used by

the Settings management infrastructure configuration system Settings
management infrastructure configuration system like assertions, expressions,
substitutions, etc -->

<metadata>

<elements>

<mainwindow>

<topleft>

<xcoord wcm:default=”10”/>
<ycoord wcm:default=”10”/>

</topleft>
<bottomright>

<xcoord wcm:default=”500”/>
<ycoord wcm:default=”300”/>

</bottomright>

</mainwindow>

<propertywindow>

<topleft>

<xcoord wcm:default=”50”/>
<ycoord wcm:default=”50”/>

</topleft>
<bottomright>

<xcoord wcm:default=”200”/>
<ycoord wcm:default=”100”/>

</bottomright>

</propertywindow>

<elements>

</metadata>

</configuration>

</assembly>

The Configuration Management Engine 250

The configuration management engine 250 is the “face” of the configuration service component 110. The engine 250 exposes the configuration present in the manifest in creating a schematized view of the settings namespace; moreover, the engine 250 provides applications with APIs to manipulate the settings contained within their namespaces. Through the API, the engine 250 provides a uniform mechanism for settings access, regardless of where those settings are ultimately stored.

For the client application 240, the engine 250 renders a view of a settings namespace through the Virtual Document Layer. The Virtual Document Layer is a hierarchical collection of objects, each of which corresponds to one of various entities exposed by the configuration service component 110 infrastructure through the configuration manifest. Namely, this layer of objects that constitutes the engine 250 core serves to provide the client with settings instance data, settings structural information, and a transactional settings change history.

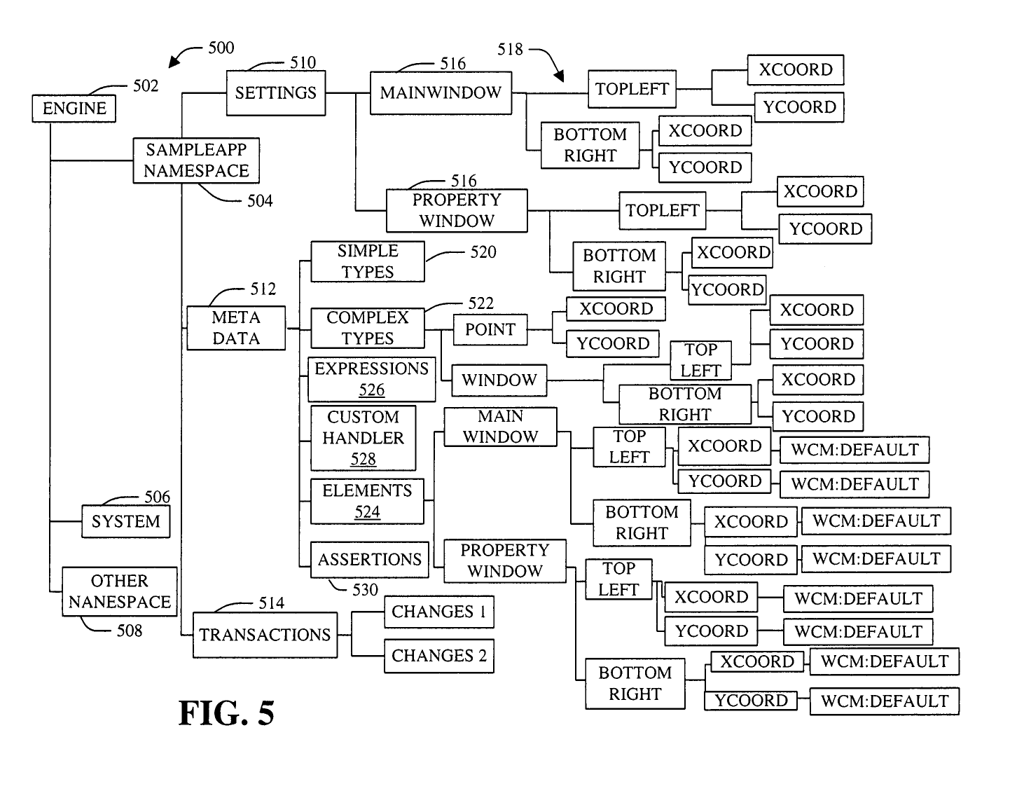

Referring to FIG. 5, a Virtual Document Layer representation 500 for the sample manifest set forth in Table 1 in accordance with an aspect of the present invention is illustrated. A top level “Engine” object 502, an instance of the SettingsEngine class, contains the list of namespaces for which corresponding manifests have been registered through the configuration service component 110, for example, SampleappNamespace 504, system 506 and other namespace 508. When a client application calls the SettingsEngine.GetNamespace( ) method, it is returned a SettingsNamespace object, which is used to retrieve or modify configuration settings through the Virtual Document Layer view illustrated in FIG. 5.

Within this SampleappNamespace object 504 that is the Virtual Document Layer view of the configuration manifest are contained three collections: the “settings” collection 510, which contains settings instance data; the “metadata” collection 512, which contains settings structural, relational, and locational information, as well as attribute information; and the “transactions” collection 514, which contains the change history record for the settings instance data. In one example, a hosted namespace collection contains the settings of hosted controls (e.g., winbar, etc.) that the application creates.

The “settings” collection 510 acts as a container for the settings instance data: it contains a list of the top-level settings 516 declared by the manifest. Each of those complex-typed top-level settings 516, in turn, acts as a container for the instances of member settings contained within that complex type. Simple-typed settings objects that are children of the “settings” collection, or any complex-typed setting object within the “settings” collection, contain the scalar value of that settings instance. Nodes that are descendents of the “settings” collection object provide read/write access to the settings value and attribute instance data; these nodes also provide read-only access to other metadata pivoted on those settings instances.

The “metadata” collection 512 acts as a repository for settings configuration information; this includes the structures and attributes of simple types 520, complex types 522, elements 524, expressions 526, custom handlers 528, assertions 530, substitutions, and refactored settings, among other metadata items represented by the manifest. The “metadata” collection 512 contains nodes for the aforementioned metadata items, each of which in turn is a collection for a particular classification of items. The “complexTypes” collection 522, for example, contains a node for each complex type defined in the configuration manifest; each of these nodes recursively contain nodes for each of their member elements, and so on and so forth. Similarly and much like the “settings” collection, the “elements” sub-collection 524 of the “metadata” node contains objects for each of the top-level settings, along with their children objects, and any attributes resting on those nodes. Unlike the “settings” collection, the “metadata” collection allows write access to the metadata items that are pivoted to the settings.

Finally, the “transactions” collection 514 contains the record of changes that have been committed to the namespace with the SettingsNamespace.Save( ) method. Transactions are only added to this collection, and changes to the namespace are only realized, upon a call to the Save( ) method. Changes can be rolled back, in accordance with transactional semantics, using the Revert( ) method.

Managed and Unmanaged API layers are the means through which client applications navigate the tree-structured Virtual Document Layer and access and modify the settings contained within. The API can be used to read from and write to settings instance data, and settings metadata, as well as read and create namespace transactions. The API can provide the functionality of authoring settings namespaces which can be utilized, for example, during the manifest compilation process. The Managed and Unmanaged APIs, along with the Virtual Document Layer are the architectural machinery behind the Configuration management engine 250.

In this example, because of the fact that Virtual Document (Virtual XML view) in employed, any node in the document can be referred by XPath. Xpath can be supported to access, point and modify information in the virtual layer from both API and the manifest.

The Server-Side Engine: The Settings Management Infrastructure Configuration System

The configuration service component 110 can act as the server in this client/server interaction by handling data access requests from the configuration management engine 250 (e.g., configuration management engine 250 (s)). In serving this gatekeeper-like role, the configuration service component 110 inherently serializes the loads and saves to the configuration store 120, thereby providing concurrency control and reconciliation semantics. Furthermore, the configuration service component 110 can enclose the functionality of resolving from and translating to nonstandard and proprietary data formats. Also provided are the channels through which communication with both standard and esoteric data-stores transpires. Additionally, because it serializes committed writes to the namespace, the configuration service component 110 can enforce the final integrity frontier through which non-valid settings values cannot permeate. Finally, the configuration service component 110 can advertise the changes made permanent to a namespace to parties interested in such information.

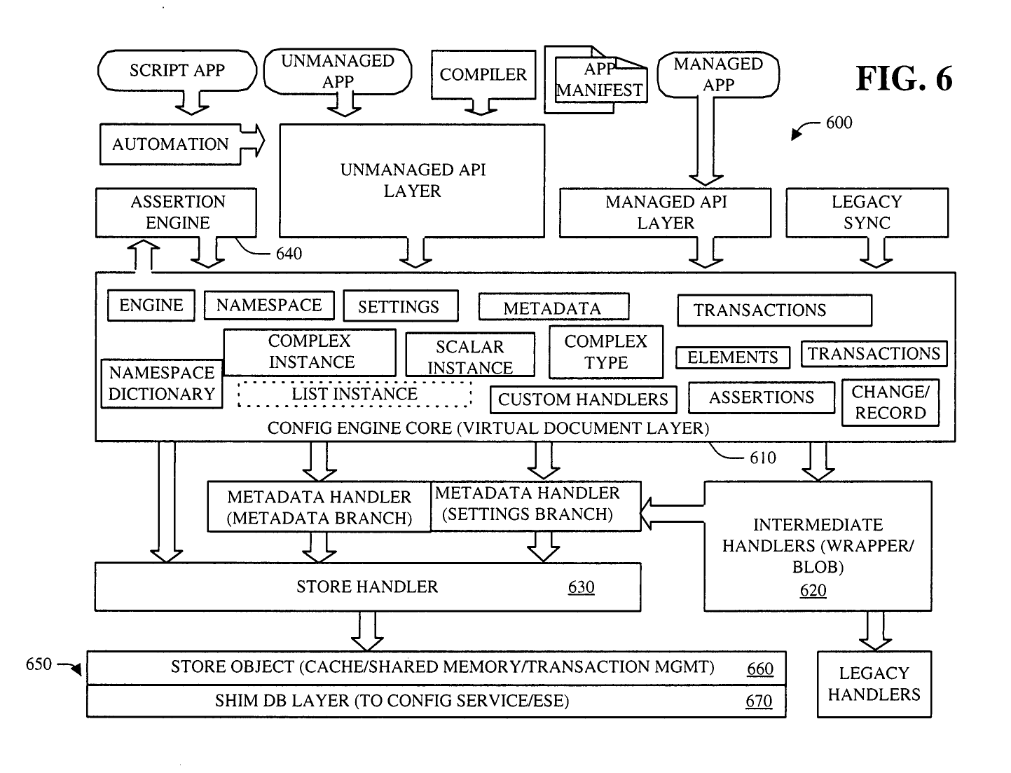

Turning to FIG. 6, a block diagram of a configuration management system architecture 600 in accordance with an aspect of the present invention is illustrated. The architecture 600 is implemented in five functional layers of components: the Server-Side Virtual Document Layer 610, the Intermediate Handler Layer 620, the Handler Layer 630, the Assertions Engine 640, and the Notifications agent (not shown). The Server-Side Virtual Document Layer 610 serves to provide the functionality as does the Client-Side Virtual Document Layer; however, in accomplishing this end it presents the Configuration management engine 250(s) (e.g., configuration management engine(s) 250) with a shared view of the settings namespace, thereby allowing multiple reads to occur against the same resource. This has the effect of conserving the system's memory reserves, a much valued optimization. If not already in shared memory, a namespace open in Read-Committed Mode triggers a Virtual Document Layer view of the namespace to be loaded. A namespace save will first reconcile the settings changes in the data-store and then reflect those changes in the shared memory view.

The Intermediate Handler Layer 620 intercepts calls from the Client-Side and Server-Side Virtual Document Layers to the data-store, and provides enhanced functionality, such as exposing and encapsulating blob (large binary objects) structure, maintaining most-recently-used (MRU) lists. This layer also performs setting name translation, qualification, handler layering, among other functionality common to all handlers. The objects in this layer implement a common interface in interacting with the data sources.

The Handler Layer 630 sits in the direct path between the Intermediate Handler Layer and the data-stores (e.g., legacy data store, for example, registry and/or INI file(s)). Handlers are objects used by the configuration service component 110 to navigate the configuration store 120 as well as legacy stores; the configuration service component 110 retrieves instance data for the settings using the various handler objects. The handler object can be aware of the settings structure defined by the manifest, as it is expected to create the appropriate objects of the configuration service component 110's navigation. Handlers can come in managed and unmanaged flavors; at their core, they can be COM objects that implement a common get/set interface. Built-in handlers can be provided for the configuration store 120, the registry 294 and/or INI file(s) 290; custom handlers that navigate proprietary legacy stores can be described by the configuration manifest and defined to implement the common handler interface.

The Assertions Engine 640 is the configuration service component 110's mechanism for implementing complex validation articulations beyond those provided for by the manifest's type semantics. For example, if the manifest author desired the behavior that a particular setting's value is bound to another setting's value by some relationship; this is an example of a requirement for an assertion, as it is a validation constraint that is beyond the scope of the system's type checker. The Assertion Engine 640 sits in the write path of configuration service component 110 managed clients; if a save operation to a namespace does not satisfy substantially all of the associated assertions, then the integrity constraint is failed and changes to the namespace are not committed. The Assertion Engine 640 can reside within the system 100, as this is the sole intersection between substantially all paths from client to store.

The Notifications mechanism is also operated out of the system 100 infrastructure. Notifications can be leveraged as the infrastructure to send notifications from the system 100 (e.g., configuration service component 110) to the configuration management engine 250. When the client application registers for notification, the configuration management engine 250 can register for subscription of “ConfigurationChanged” events with Notifications; in doing so it passes along query criteria, namely the namespace id. Upon a commit to a namespace, induced by a save operation, the configuration service component 110 can generate one Notification event describing substantially all the changes that are a part of that operation. The Notification service can then filter the events based on namespace id, and route the appropriate events that match the filter criteria to the configuration management engine 250. The configuration management engine 250 can then do more granular filtering of the namespace and package and return the changes as specified by the application.

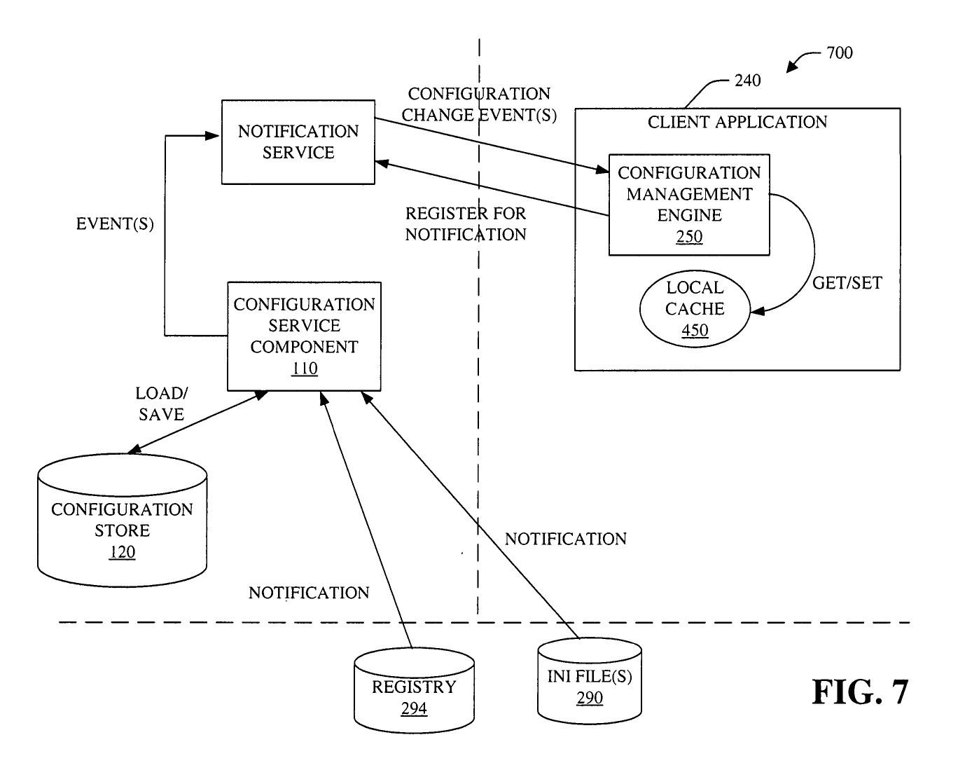

Turning briefly to FIG. 7, a block diagram of a configuration management system architecture 700 in accordance with an aspect of the present invention is illustrated. The architecture 700 illustrates notifications-related interactions.

Persisted State: The Settings Management Infrastructure Configuration System Store

Referring back to FIG. 1, the configuration store 120 is generally the location for manifest-described settings to reside in the system 100. The configuration management system 100 infrastructure storage implementation is abstracted away from the client application 240. Thus, the client application 240 need not know intimate details about how the system 100 stores its state.

In one example, the configuration store 120 is built on a JETDB database. This implementation decision is accompanied by the benefits associated with using a database as the underlying data-store: namely, role-based security; DBMS-enforced data integrity, which strongly associates data with types; transaction processing, which incorporates Atomicity, Consistency, Isolation, and Durability, the so-called ACID properties; query optimizations; distributed data processing; data replication; amongst several other database associated utilities and extensions. These advantages come for free if the application decides to store its settings within the configuration store 120.

Briefly referring back to FIG. 6, the architecture 600 can further include a store management layer 650 that sits between the store handler layer 630 and the actual JETDB database. This layer 650 includes a store objects 660 and transaction objects 670 that serve to maintain consistency between the database and the namespace view presented to the client applications. On commit operations to a particular namespace, settings values, metadata, and transaction records within the database must be reconciled with any views of that namespace opened by client applications in Read-Committed Mode.

In summary, in this example, settings which reside in the configuration store 120 will have changes coming exclusively through the configuration component 110, and thus will be fully subjected to integrity restrictions described by the manifest; this settings storage model also offers a complete change history; such benefits can only be approximated at best for legacy store maintained settings.

Manifests and Schema

Manifests and the schemas of which they are composed are the initiation of an application's appearance into the configuration management arena through the system 100's infrastructure. This section presents an overview of assembly manifests and the namespaces into which they are compiled, followed by a sample manifest creation walkthrough, and culminates with a discussion of divergences of the supported manifest schema definition language with the XML Schema Definitions Language (XSDL).

Those skilled in the art will recognize the manifests and schema described herein are examples of manifests and schema that can be employed to protect the present invention. It is to be appreciated that any type of manifest and/or schema suitable for carrying out the present invention can be employed and all such manifests and schemas are intended to fall within the cope of the appended claims.

Component Manifests and Namespaces

In one example, an application register its settings with the system 100 infrastructure using the <configuration> section of the component manifest. The component manifest is a textual document describing the details of the component. The system 100 infrastructure compiles the <configuration> section of the component manifest, binds it to the <assemblyldentity> section, and stores it in a virtual account known as a namespace.

Component manifests

In this example, the component manifest contains the application identity, the security descriptor, the list of binary files that define the application, folders created by the component, along with the configuration section; also included in the component manifest are the installed registry entries, component dependencies, services installed by the component, custom commands run during setup, the categories to which the component belongs, and any additional properties of the component.

Each of the abovementioned sections of the component manifest serves as a beacon through which the application broadcasts selected information to specified services. The <assemblyldentity> section of the component manifest serves as a unique identifier for a particular installation of a component, and, as mentioned previously, is composed of the application's name, version, language, Deploy Id, Process Architecture, and public key token. Much of the information present in the component manifest is utilized by the installation and deployment services.

The configuration section of the component manifest contains the settings schema, as well as settings metadata (default values, attributes, assertions, etc.) related to the application. The layout of an exemplary component manifest is illustrated in Table 2:

TABLE 2
<?xml version=″1.0″ ?>
<assembly xmlns:xsd=″http://www.w3.org/2001/XMLSchema″

xmlns:xsi=″http://www.w3.org/2001/XMLSchema-instance″
xmlns=″urn:schemas-microsoft- com:asm.v2″>

<assemblyIdentity name =
“http://www.microsoft.com/state/WcmSample1”

version = ″1.0.0.0″
language= ″en-us″/>

<configuration>

...

</configuration>
...

</assembly>

Namespaces

During the process of component manifest registration, the system 100 infrastructure compiles the <configuration> section and persistently stores this compilation as a namespace. The namespace is given an identity, which serves to associate it with the component installation from which it was spawned.

The system Namespace identity is defined by the assembly identity, along with the deployment id provided by the installer of the manifest. Using the assembly identity provides a unique namespace for the application settings. For example, the name/identity segment of a manifest can be comprised of:
Assembly Identity=Friendly name+Version+<Language>+<Public Key Token>+Deploy ID+Process Architecture

Configurations Within the Manifest

The <configuration> section of the manifest is used to define configuration related information for the application; it is bisected into two sections, schema and metadata:

TABLE 3
<configuration xmlns:xs =″http://www.w3.org/2001/XMLSchema″

xmlns:wcm=″http://schemas.microsoft.com/WMIConfig/2002/State″
xmlns:app=″http://www.microsoft.com/state/WcmSample1″ >

<!-- Schema- Valid XSD schema for this manifest -->
<configurationschema>

...

</configurationschema>
<metadata>

...

</metadata>

</configuration>

Schema

The <configurationSchema> section lays out the names and types of setting(s) expected by the application. For example, this schema section can be compliant with the W3C XML Schema Definitions language (XSD), and used to validate settings values later provided in the Metadata section, or set in runtime by the application.

The usage of XSD allows developers to reuse this powerful and general purpose grammar instead of learning yet another private description format; additionally, developers can benefit from the tools support and constant improvements that this standard enjoys.

The structure of the <configurationSchema> section can be a well-formed XML Schema Definition, and can be validated against the XSD schema itself:

TABLE 4

<configurationSchema>

<xs:schema

targetNamespace=″http://www.microsoft.com/state/WcmSample1″

```
  attributeFormDefault=″qualified″
  elementFormDefault=″qualified″
  xmlns:xs=″http://www.w3.org/2001/XMLSchema″>
```

<!-- Define types -->

...

<!-- Define setting instances -->

...

</xs:schema>

</configurationSchema>

A simple example for an integer setting called FOO can be written as:
<xsd:element name=“FOO” type=“xsd:integer”/>

In summary, the usage of XSD for schema definitions in the manifest is logically equivalent to declaring names and types for objects or variables in code, before their instantiation and later use. The actual objects, when instantiated, will contain different values over their lifetime, but their names and types, or schema, will remain constant.

Metadata

Beyond specifying types and names of settings, the author can provide additional metadata, such as attributes, settings context, access control, expressions (e.g. foo =⅓ of System.Display.Width), complex validation rules, known as assertions (e.g. foo must be divisible by 64), amongst other metadata; other than attributes, most of these items are generally beyond the scope of XSD. Similarly, a supplementary manifest can contain language specific data. For example, localization and expression metadata is almost always required by real applications for full description of their settings. Further, default values of settings, and custom attributes related to roaming, migration etc., may need to be specified as well.

These settings enrichments and dependencies are enumerated in the <metadata>section. Decorating settings with metadata brings the advantages of Discoverability, Semantics, and Integrity. Settings become more discoverable to management service(s) 260 when associated attributes are turned on: for example, the Roaming Service can query for settings whose “Roam” attribute is set to “true”. When certain semantic attributes, such as “RestoreToDefaults”, are added to the settings, any reader of the manifest gains knowledge about the consequences of changing those attributes. Furthermore, other metadata, such as expressions and assertions, guide the Settings management infrastructure configuration system in enforcing the integrity constraints intended by the application authors and management service(s) 260.

Sample Manifest Creation Walkthrough

For purposes of explanation, the classic application creating a window to display “Hello World” can be employed. The <configuration> section only will be modeled for purposes of brevity. For purposes of illustration, assume this application requires four settings as follows:

TABLE 5

| Setting Name | Setting Type | Initial Value |
|---|---|---|
| WindowText | String | “Hello World” |
| KeepWindowOnTop | Boolean | True |
| WindowLayout | Window Type | <256, 256, 512, 512> |
| TextFont | Font | “Arial, 10” |

In order to create a <configuration> manifest section for the above settings, the schema for the settings is first defined in the <configurationSchema> section, and metadata is added to it in the <metadata> section.

Defining Schema

Names

A setting is associated with a name, which uniquely identifies that setting within the scope of its declaration. A top-level setting, for example, has a name that is unique within the namespace of this application. Within a complex type definition, a sub-setting is uniquely identified by its name. Therefore, the fully qualified name of a setting, within a namespace, is unique. In one example, names are generally restricted to any valid alphanumeric combination, as is allowed by XSD.

Types

In addition to a name, a setting also has a declared type, so that instance values can be strongly typed and verified by the configuration service component 110.

Much like variables declared in compiled source code, settings elements can be declared to be of primitive types, such as integer or Boolean; simple type(s) (e.g., a restriction on primitive type(s) (e.g., as set forth in XML Schema Part 0: Primer, W3C Recommendation, 2 May 2001, W3C); or, they can be instances of more complex classes (complex types) which can contain many members. Simple types can be strongly bound to values; where as complex types can have element content. The elements within a complex type, in turn, can be of simple type or of complex type.

The two simple-typed settings in the example can therefore be easily represented as follows:

<element name=”WindowText“ type = “xsd:string“ >
<element name = “ KeepWindowOnTop“ type = “xsd:boolean“ >

The third member of the example, however, is more complex, as it models a class that represents a window. For example, assume the object-model representation of the Window setting is a class that has four integer members representing the two (X, Y) pairs of the opposite corners of the rectangle. XSD easily allows modeling such classes by using a complex type definition construct, as illustrated in Table 6:

TABLE 6
<xsd:complexType Name=”WindowType”>

<xsd:sequence>

| | |
|---|---|
| <xsd:element name = LeftX | Type = “xsd:integer” > |
| <xsd:element name = TopY | Type = “xsd:integer” > |
| <xsd:element name = RightX | Type = “xsd:integer” > |
| <xsd:element name = LowerY | Type = “xsd:integer” > |

</xsd:sequence>

</xsd:complexType>

Once the new type is defined, one or more settings elements of this class can be declared as:
<element name=“WindowLayout” type=“WindowType”>

It can be appreciated that most .NET classes are directly serializable into equivalent XSD representations through a process known as “reflection”, which developers can leverage for an easy and consistent way to quickly model real settings objects directly from their code. The serialization of the .NET ApplicationSettingsBase class into manifest schema objects is discussed in further detail below.

Parallel to the concept of well-typed settings is the notion of type reusability. The reuse of types is a very powerful concept; the implication is that public or standard type definitions, developed internally, or by external companies, can simply be reused in a settings manifest by making an explicit reference to those source definition documents. This is similar to the concept of a <#include> for a C/C++ compilers; in writing XSD-compliant schemas, this is accomplished using the xmlns attribute on a <schema> element. The example set forth in Table 7 illustrates the usage of XSD namespaces through the xmlns attribute; in doing so, an element “MyIP” is declared to be of the “IPAddress” type, defined by the Microsoft NetworkSchema namespace:

TABLE 7

<xs:schema
targetNamespace=”http://www.microsoft.com/state/WCMSample1”

xmlns:FOO = http:// Microsoft.com/schemas/NetworkSchema>

<!—FOO now points to some Microsoft network schema on
the web which

defines IPAddress type>

<element name = ”MyIP” type = ”FOO:IPAddress”>
<!—MyIP is now declared as an object of type IPAddress
whose source is pointed

to by FOO>

The targetNamespace attribute on the <schema> element in the example above carries the implication that type(s) defined within this schema document can be reused by other XSD schema documents and XML instance documents by pointing to that target namespace.

In this example, rich typing is very strongly encouraged as this indicates consistent and clear semantics to administrators, users, UI and other services that consume the application's settings. A class construct like “IPAddress” is far clearer and more robust than simply storing four integer settings that are read in by the app code and then appended to create a IP address internally.

In one example, to encourage this, the system 100 infrastructure defines useful classes such as Colors, Fonts, Window, amongst a variety of others, in a common type definition schema document.

Defining Metadata

Thus far, the names, types, and layout of the settings have been defined in a consistent and verifiable schema. Adding comments, attributes that dictate how these settings roam/migrate, and other custom attributes to the settings can immediately add enormous value to users, administrators and management service(s) 260. Furthermore, there are numerous other pieces of metadata on localization, access control, scoping, validation (e.g., via. assertions) that are dealt with in more detail in later sections.

Comments

In one example, comment(s) are expected of settings, and can be added by means of a description attribute, as in the example below, which extends our previous declarations:

<element name=”WindowText “ type = “xsd:string“

wcm:description = “this setting represents the text
that will be shown by the

hello world app” >

Note that the description attribute is prefixed with the “wcm:” namespace, which acts as a scope resolution operator. This indicates that this attribute is not an XSD type attribute that is normally part of the type definition. Rather, this attribute is instead pre-defined by the owner of the “wcm:” namespace, the system 100 infrastructure schema, and is thus meant for system 100 infrastructure which will recognize and process the attribute.

Manageability Attributes

Service attributes indicate metadata for appropriate behavior choices for those services on the setting. For example, to make a setting participate in the Roaming Service, one can add the appropriate attribute, wcm:roam=“True”, on that setting. More manageability service related attributes can be added in the same way; for example, a wcm:migrate tag can point to an XSLT transform to instruct the Migration Service on how to migrate that setting.

To allow the WindowText setting to roam between machines but to prevent KeepWindowonTop from roaming, the following attributes can be to their base declaration:

<element name=”WindowText” wcm:Roam=”Yes” >
<element name= “ KeepWindowOnTop“ wcm:Roam=”No” >

In one example, there are several predefined service attributes for Roaming, Migration, Backup, among other management service(s) 260.

While the model predefines well-known attributes, such as those prefixed with the “wcm:” tag set forth above, third-party developers and future services can define more custom labels that help them identify, classify, or manipulate settings by using a similar labeling mechanism. For example,

<element name = “ KeepWindowOnTop“ type = “xsd:boolean“
mystuff:mylabel =”Somevalue”>
<!—some service looking for settings that meet mystuff
criteria can now use this>

Such labels, or attributes, are not backed by any predefined semantics by the system 100, but can be easily queried for by service(s) that plan on using them. Preventing collision in the names of custom labels requires discipline on the part of their users to create private namespaces.

Settings Context

Most applications have two types of settings:
Shared Settings: global settings for the application, whether per-application settings or machine-wide global settings.
Per-User Settings: settings that are different for each unique user, such as browser preferences, for example.

If the application is installed in a system-global location, such as the Program Files directory, then Shared settings are global to the entire machine. Such settings are traditionally saved in HKLM hive of the registry.

If the application installs in a user-specific location, such as the user's profile, then naturally there is no further distinction between Shared and Per-User settings, since Shared settings are also inherently Per-User settings.

<element name=”WindowText “ type = “xsd:string“
wcm:Context=”Shared”>
<!—This setting will have the same shared value for
all users>
<element name= “ KeepWindowOnTop“ type=“xsd:boolean“
wcm:Context =

”User”>

<!—This setting will be maintained per user>

When a setting has been marked as Per-User, the system 100 tracks different values (one for each user context) of this configuration. When an application calls for such a setting, the current user context is used to provide the appropriate value. For shared settings, users see the same value; changes made to such global settings by any one user are transparent to other users.

For example, by default, if no context is indicated, the system can treat settings as Per-Component, or globally.

Settings Visibility and Access Control

In addition to declaring the scope of settings, an application can restrict access to one or more of its settings. For example, by default, settings can be read/write enabled for the current user and administrators (subject to validation rules, of course), unless a security descriptor tag is provided. Security tags can contain ACL information described by the Security Descriptor Definition Language (SDDL).

In one example, in addition, shorthand wcm:ReadAccess and wcm:WriteAccess tags can be allowed, which can contain well defined group of security principals in a comma separated list. Role-based security is also supported by including system defined roles in the list of principals. This can be a readable version of the equivalent SDDL expression.

<element name=”WindowText “ type = “xsd:string“
wcm:ReadAccess=”All”,

WriteAccess=”Power Users, Administrators”>

<!—everyone may read to it (if in scope) and only power
users and admins may

change values>

<element name= “KeepWindowOnTop“ type=“xsd:Boolean“

wcm:ReadAccess =”Application”

wcm:WriteAccess=”Redmond\John”>

<!—Only the app itself can read the setting and only John
can write to it >

Notice that in this example, “KeepWindowOnTop” has an access set to “Application”, the intent of which is that only the original owner application will be allowed to read/write values for this setting: other applications will be denied access to this setting.

This is simply a means to indicate that such settings are private from other applications, but is not designed as a serious security implementation. Rather, it is merely a useful way to filter out unnecessary sharing. Administrators have the ability to read and write into any setting.

Default Values

Applications typically want to (and should) provide default values of their settings at development time. This can be done as illustrated:

TABLE 8

<metadata>

<!-- Type defaults -->
...
<!-- Instance defaults -->
<elements>

< WindowText wcm:default = “Hello World” />
<KeepWindowOnTop wcm:default = “True” />
<windowLayout>

<LeftX wcm:default = “172” />
<TopY wcm:default = “253” />
<RightX wcm:default = “28” />
<LowerY wcm:default = “05” />

</windowLayout>

</elements>

</metadata>

In one example, the system 100 requires default values for substantially all settings in the manifest.

Legacy Handlers

As discussed previously, applications may want to continue storing settings in the registry 294, or in other legacy stores, such as INI file(s) 290, databases, etc., for reasons such as backward compatibility. While application(s) 240 can store their settings in the configuration store 120, a way to access settings in legacy stores can, optionally, be provided. Legacy information can also be provided in the metadata section of the manifest.

Settings Integrity, Consistency, Security, and Recoverability

Settings Integrity: Expressions and Assertions

Applications can use the power of the system 100 infrastructure to express the values of certain settings as dependencies of the values of other particular settings; these constructs are known as expressions. Furthermore, the system 100 infrastructure can leverage this capability to enforce validation rules and integrity constraints on setting values; such restrictions on settings values are referred to as assertions. Following is a discussion of the syntax and appropriate usage of expressions and assertions in the manifest.

Expressions

Expressions are used to stipulate that settings are bound to the values to which they, the expressions, evaluate. Settings management infrastructure configuration system supports a rich expression grammar in its manifest schema. Expressions are commonly used to define dependencies between settings.

For example, assume that a setting, “WindowHeight”, should be one-third of the value of another setting, “DisplayHeight”.

To express the dependency in the example above, the manifest would include the following element definition:

<element name=”WindowHeight“ type = “xsd:integer“

wcm:default=”exp(‘myExpression’)”/>

and the following expression definition in the metadata section:

<metadata>
...
<expressions>

<expression name=”myExpression“>

#/settings/DisplayHeight / 3

</expression>

</expressions>
...
</metadata>

Expressions can be built from mathematical and logical operators, in addition to system 100 infrastructure supported functions, such as, Enum, the Range function, etc.

Assertions

Assertions allow the application author, or administrators, to write validation statements about settings and configurations stored by the system 100, or other configuration data, such as security information on files or user account information, for example. An application author can provide assertions about the valid ranges of each setting or about the interactions between settings; for example, setting X must be between 5 and 15, or “button color” must not equal “button font color”. Administrators can provide assertions that drive the configuration of a system or application in their environment. For example, passwords must be more 5 characters and satisfy complexity requirements.

These assertions are checked when they are created and as the system changes. If the assertions become false a configuration change can be failed and/or a notification event generated. If an event is generated, then higher-level management service(s) can subscribe to the event and take the appropriate action.

Assertions provide a powerful mechanism for representing the valid changes to the configuration. Attempts to violate these assertions are reported or failed and the appropriate recovery actions can be performed. The system 100 can store assertions as part of its repository. It provides security controls for assertions and access APIs for their manipulation. The system 100 can also manage/tracks relationships between assertions and settings so that it can identify what assertions must be checked when a given setting is changed. A transaction history on assertions can also maintained.

Here are some examples of assertions:
button color must not equal button font color
passwords must be more 5 characters and satisfy complexity requirements
A color setting may only have allowed values of RED, GREEN and BLUE.
An integer setting may have to be in a particular numerical range, say from 1 to 52.
A date setting may have to fulfill a certain pattern e.g. MM/DD/YYYY

For example, say the setting WindowText is only allowed to be one of the 3 predefined strings. To express this, an assertion such as provided in Table 9 can be created:

TABLE 9

<metadata>
...

<assertions>

<assertion name=”myAssertion“

expression=″Enum.IsOneOf(#/settings/WindowText,
“Hello World”,

“Another String”,

“Last Alternative”)”

description=″Window Text can be one of 3 values″
satValues=″Value(#/settings/WindowText ,
“Hello World”)″ >

</assertion>

</assertions>

...
</metadata>

The Enum.IsOneOf operator is used to restrict the WindowText string to be one of a predefined set of strings (a similar Range operator can be used for integers). The satValues attribute specifies the satisfying value that the setting should take if the assertion fails.

Assertions checks are run when a client application tries to commit a namespace. In one example, if the set of values in the namespace fails any of the assertions, then the commit fails and changes are not saved.

Settings Consistency: The Notification Model

Much of the power and dynamism of the system 100 infrastructure is drawn from the fact that numerous clients can access and potentially make modifications to a settings namespace (e.g., simultaneously). This enables many manageability scenarios; an example is the classic Group Policy scenario, in which a new policy has been pushed onto a machine which involves changing a particular setting's value, such as an application's background color. In this scenario, the application opens its settings namespace, makes modifications, and commits those changes; subsequently, Group Policy opens that application's settings namespace, makes its desired changes, and commits those changes back to the persisted setting store—configuration store 120. The application has a requirement to be aware of the changes that Group Policy made during runtime. Out of this requirement, and out of other consistency requirements born from runtime scenarios where immediate knowledge of a setting change is a significant, stems the Notification Model.

Notifications enable applications to receive notice of a setting value change in a particular namespace of interest. This allows applications to reconcile their knowledge of settings values with an effective “live” view of the settings store.

For example, an application 240 can register for a notification on a namespace. Following a commit operation on that namespace, an event (e.g., Notification event) can be issued and sent to that application 240, informing it that a namespace save has occurred. The application 240 can then query the namespace for all the settings whose values have been changed since the last transaction. Through this mechanism, applications 240 are able to listen for changes to the settings namespace from external sources. Applications 240 listening for notifications on a namespace are therefore have a consistent view of the settings within that namespace.

In one example, as mentioned previously, the Notification Event mechanism is leveraged as the infrastructure by which notifications are sent. Initially, the client application uses the system 100 API to register and unregister for change notifications on the desired namespace. For a commit operation exacted on a namespace, the configuration service component 110 generates a Notification event. The Notification service will filter these events send notifications to registered clients accordingly. The semantics of this operation is illustrated in greater depth herein.

For example, there are three variations of notifications for which a client application can choose to register: depending on their specific functionality requirements, clients can opt for a callback-based notification; otherwise, they can prefer event-based notification; if neither of these two semantics are desired, the client can also opt for a message based notification. Notifications typically contain the transaction id of the commit operation from which they were triggered; this can then be used to query for specific changes in the settings namespace.

Settings Security

Many applications and components have visibility and access control requirements for their settings stores; certain applications may assert that they are the only ones allowed to write to their settings; others may have even more sensitive settings of which even reading is restricted. The problem space of configuration settings management is accompanied by a wide range of requirements and demands from various applications about the security of their settings.

The system 100 infrastructure attempts to cover the differing conditions and granularities of security required by client applications and management service(s) 260. This is accomplished through the application of two main authorization models: principal-based authorization and code access-based authorization. Using these two models, the system 100 infrastructure aims to simulate the desired restrictions of managed applications, as well as the expected behaviors of legacy clients.

Principal-Based Authorization

Principal-based authorization grants access to settings objects based on the identity of the user. For example, these authorization decisions can be made based on Access Control Lists, groups and users, and are augmented by a roles-based mechanism. These Access Control Lists, or ACLs, can be applied to individual setting items. The ACLs can be defined using the Security Descriptor Definitions Language, the SDDL. These ACLs can be specified for settings in the manifest at a per-setting granularity; if no such ACL is specified, then the setting will inherit its access control using the standard attribute inheritance model. When defining a settings access control, the manifest author can use the system's predefined security descriptors, those defined in the security descriptor section of the component manifest, or they can embed the SDDL string in the configuration manifest itself. Additionally, there is the superimposed security constructs of roles or tasks; these are also during manifest authoring.

In one example, a key point in the principal-based authorization design is the granularity of authorization control. In this example, the system 100 infrastructure security model allows individual settings, including member of lists and complex types, to be separately secured. For example, for a manageable system that inheritance and other authorization information re-use mechanisms can be provided.

In another example, a setting, operator assertion, or other system 100 infrastructure configuration system object has authorization information associated with it. For some objects, such as types and developer assertions, the authorization information will be implicit—this data is managed as read-only (i.e. fixed by the developer) and available only if the namespace is available to the reader. Expressions and substitutions also fall in this category. In addition, installed namespaces will not permit the creation of any new settings or types—these types of changes must be made before the namespace is signed or installed.

Code Access-Based Authorization

Code access-based authorization, or code access security (CAS), targets the securing of which programs are allowed to perform a given operation. The primary target of the technology is to prevent untrusted or semi-trusted applications from using the full access rights of the user—for example, running a program downloaded from the net can't perform administrative actions. CAS deals with authorizing method calls through the managed and unmanaged layers of the system 100 infrastructure configuration system API.

CAS secures the methods of an API and not objects. The details of how security checks are performed are different from principal based security but it does have commonality in that both authorization systems require the security designer to select a set of access rights that can be defined and will be checked. The access rights of the caller are defined in the manifest. These rights can be augmented by running a CAS management tool and granting the component more CAS rights.

In one example, the system 100 infrastructure configuration system API CAS. Previously, granular rights but there are also a small number of rolled up permission sets that represent the common data points in the spectrum. The rolled up permission sets are:
Untrusted network application
Semi-trusted network application
Local application
Administrative tool
Trusted tool
Authoring application

The CAS security provides access control over the level of access the caller has to namespaces within the system. Thus, rights need to be more granular than indicating a GetSetting API can be called. This is because when an untrusted network application performs a GetSetting API the administrator wants to limit him to his own namespace. Conversely, in this example, an administrative tool must be able to access any namespace.

Settings Recoverability

One of the most fundamental inadequacies of existing state storage models is their fragility: namely, upon any modification to the system's state, the previous state is lost, and the system is irremediably bound to its new and potentially undesired state. This problem is remedied by the system 100 infrastructure recoverability semantics.

Settings changes made through the system 100 API are not propagated down into the persisted configuration store 120 until the client calls a namespace save. This method call invokes a commit operation, the process of which is guided by transactional semantics. First, the candidate namespace is validated against the system's integrity constraints, manifest defined and/or operational. This involves a primary validation by the type checker, followed by evaluation by the assertions engine of the assertions placed on settings within that namespace. If the settings changes are corroborated by the system's integrity checks, then the candidate namespace is transactionally committed as a whole to the configuration store 120: the action is given a unique transaction id and saved in the transaction log. Out-of-band or partial changes cannot be saved to the persisted configuration store 120 outside of a commit operation.

The system 100 infrastructure offers much-desired state recoverability by allowing any of the system's previous states to be restored. This can be accomplished through the use of the revert operation. The system's state can be rolled back to any transaction; the desired outcome is achieved by specifying the transaction id associated with the desired state to the revert operation. As with any modifications to a settings namespace, the effect of a revert operation is not realized until a subsequent commit operation is exacted, resulting in yet another transaction. Unlike the limited settings stores of old, the system 100 infrastructure ensures the consistency and recoverability of the system's state through transactional processing.

Settings Interface: The System 100 Infrastructure API

In this example, the system 100 infrastructure is a conglomerate of three major architectural components: the configuration store 120 the configuration service component 110 and the configuration management engine 250. The configuration store 120 is the underlying database that maintains the settings namespaces. The configuration service component 110 serializes access to the configuration store 120 for reading and writing into specified settings namespaces, while preserving data integrity and security. The configuration management engine 250 loads in the client application as an API, and provides an interface to the application's namespace, in addition to other application namespaces, provided the appropriate permissions. The API exposes functionality that allows variations of settings access, modification of integrity rules, and the creation and transfer of namespaces as a whole.

The system 100 infrastructure provides client applications both managed and unmanaged API for applications to access and update settings. The API can be used to access any settings declared through the manifest—whether they live in the configuration store 120 or in legacy stores. In one example, applications are strongly encouraged to use the system 100 API to access their settings even if they live in legacy stores for compatibility and interoperability reasons.

The API exposes the settings namespace as a Virtual XML Document that consists of Metadata (types and attributes of settings), Settings (instance values), and Transactions (change history). For example, Any XML node in the document can be accessed via XPath navigation.

API Functionality Classification

Exemplary functionality exposed by the system 100 API can be logically categorized as follows:
Namespaces Access API
   Load/Save namespaces in a transacted manner
   Enumerate namespaces managed by the system 100
   Import/Export all settings values into a portable XML instance document
   Perform legacy synchronizations with legacy stores
Settings Access API
   Get/Set an individual setting's value
   Get/Set settings' metadata such as attributes/expressions/defaults etc.
   Enumerate settings/metadata in a given namespace
Query API
   Query for settings with given attribute/metadata using XPath
Transactions API
   Retrieve change history: enumerate settings changed since a timestamp
   Revert settings back up to particular transaction
   Find transactions involving a particular setting
Assertions API
   Create/Merge assertions for a setting
   Check the validity of an assertion
   Run assertions on a namespace or individual setting
Notification API
   Register/Unregister for notifications on setting changes
Authoring API
   Create namespaces
   Define complex types and simple types
   Declare elements and attributes
   Register assertions, substitutions, and custom handlers

API Usage Scenarios

The richness of functionality exposed by the system 100 API allows for many different usage scenarios. Most of those scenarios fall into four groups: so-called Traditional Client Application Scenarios, where applications are mostly interested in their own settings; .NET Scenarios, where applications create and consume their settings in classes that extend the a client base class, thereby rendering the manifest authoring and settings access processes transparent; Manageability Scenarios, in which system services are providing change control over particular applications, and are therefore interested in those applications' settings; and Authoring Scenarios, in which a specific type of application is interested in creating new namespaces for other applications.

Traditional Client Application Scenarios

In Traditional Client Application Scenarios, client application(s) 240 are interested in loading their settings namespaces, reading and writing to settings and metadata within their namespaces, and listening for external modifications to settings and metadata contained within their settings namespaces. Such applications 240 are interested in committing changes that they have made to settings and metadata within their namespaces.

For example, in order for an application 240 to use the configuration management engine 250, applications 240 can prefix their code with the following statement, which includes the system 100 API container:

using System.Configuration.Settings; //System 100 API's

First, an application opens its settings namespace in order to read or write to settings or metadata that it defined in its manifest. To do so, applications instantiate a 15 Namespaceldentity object, and populate it with their name, version, culture, and public key token. Applications can then use this Namespaceldentity object to retrieve their namespace, returned as a SettingsNamespace object. The sample excerpt below illustrates the process:

TABLE 9

//

// Declare and Allocate a namespace identity
//
SettingsNamespace appNamespace = null;
NamespaceIdentity namespaceID;
namespaceID = new NamespaceIdentity(

| ″http://www.microsoft.com/state/WcmSample1″, // URI name | |
|---|---|
| ″1.0″, | //version |

| | |
|---|---|
| ″en-US″, | // language ID |
| null); | |

//
// Open the application namespace
//
appNamespace = SettingsEngine.GetNamespace(namespaceID,

NamespaceMode.SettingChangeMode,
System.IO.FileAccess.ReadWrite);

The SettingsEngine.GetNamespace( ) method takes the Namespaceldentity object; the content mode, which identifies the portion of the store that is to be modified; and the access mode, which specifies the access rights with which to open the store. The content mode can take on a variety of values, which map to settings changes, metadata changes, reverting changes, legacy synchronization, compaction, compilation, authoring, etc. In this particular example, the namespace is opened with SettingChangeMode, which allows the settings values within the store. ReadWrite file access is also specified, which allows access to the current settings values as well as modifying those values.

The GetNamespace( ) method returns the SettingsNamespace object, which is used to retrieve or modify configuration settings. Settings are stored in the form of a SettingItem object. In order to retrieve a setting from a namespace, the application must call the GetSetting( ) method from within the SettingsNamespace instance. For example:

TABLE 10
// Declare a SettingItem

SettingItem appWindow = null;

// GetSetting returns the SettingItem

appWindow = appNamespace.GetSetting(″myAppWindow″);

The GetSetting( ) method is called from within the SettingsNamespace instance (appNamespace); the method takes as a parameter a String path for the setting to retrieve. The GetSettingo method returns a SettingItem object, and all the members inside the SettingItem object have been read consistently and cached to provide repeatable reads. Further updates to this SettingItem instance will be isolated from the namespace. Settings can be accessed in ReadCommitted mode as well, by directly accessing the Settings container within the SettingsNamespace instance.

In order to retrieve elements within a setting of complex type, a call is made to the GetSettingltemByPath( ) method within the SettingItem instance. For example, assume that the “myAppWindow” setting contains a “topLeft” setting, which itself contains a “xCoord” setting; and the “myAppWindow” setting also contains a “title” setting. The sample code below retrieves these sub-settings from within the “myAppWindow” setting, and print their names, types, and values to the console:

TABLE 11
// Declare the SettingItem variables

| | |
|---|---|
| SettingItem | topleftX = null; |
| SettingItem | windowTitle = null; |

// GetSettingItemByPath returns a SettingItem

topleftX = appWindow.GetSettingItemByPath(″topLeft/xCoord″);
windowTitle = appWindow.GetSettingItemByPath(″title″);

// Print the names, types, and values of the settings to the console

Console.WriteLine(″{0}: type={1}, value={2}″,

topleftX.Name,
topleftX.ValueType,
topleftX.Value);

Console.WriteLine(″{0}: type={1}, value={2}″,

windowTitle.Name,
windowTitle.ValueType,
windowTitle.Value);

The GetSettingltemByPath( ) method, called from within the SettingItem instance, takes as a parameter a String that contains a path to the setting to be retrieved. The path is relative to the current setting; the GetSettingItemByPath( ) method can only be used to retrieve settings from within the SettingItem instance. The GetSettingltemByPath( ) method returns another SettingItem instance that contains the sub-setting specified by the path.

The SettingItem object can also be used to modify the value of a setting. To accomplish this, a live SettingItem instance is needed, one that was retrieved from the SettingsNamespace instance, or a child SettingItem instance of such. Once the live SettingItem instance is obtained, changes can be made to its Value property. Changes to a setting in a namespace are finalized through a call to the SetSetting( ) method from within the SettingsNamespace instance. Changes to the namespace are committed by calling the Save method from within the SettingsNamespace instance. The following example, which extends the sample code above, illustrates how to set a setting value and commit the update to the persistent configuration store 120:

TABLE 12

// Modify the settings values

topleftX.Value = 300;
windowTitle.Value = ″New Window Title 2″;

// Update the settings

appNamespace.SetSetting(appWindow);

// Commit update to persistent store

appNamespace.Save( );

In the example above, the “topLeftX” and “windowTitle” SettingItem instances are retrieved from the GetSettingltemByPath( ) method from within the “appwindow” SettingItem instance. Since they are children, in that respect, of the “appWindow” SettingItem instance, changes to their values are updated in the namespace when the SetSetting( ) method is called with the “appwindow” SettingItem instance as a parameter. Finally, the update is transactionally committed to the persistent store through a call to the Save method from within the SettingsNamespace instance.

Client applications can also be interested in listening for modifications to their settings and metadata from external sources, such as other processes or management service(s) 260. This can be accomplished through a mechanism known as notification. If an application has registered for a notification on a particular namespace, then whenever a change is committed to that namespace, a notification (of that change) is sent to the application. The notification invokes a special handler, specified by the application in the registration process. Applications can call the RegisterForNotification( ) method from within the SettingsNamespace instance to register for a notification on that namespace. Applications can also call the UnregisterForNotification( ) method from within the SettingsNamespace instance to stop receiving notifications of changes on that namespace.

.NET Scenarios

In one example, the system 100 .NET applications can create and consume a group of settings items in a transparent manner, without having to create an explicit manifest or use the configuration management engine 250 API. In this scenario, an application uses a ApplicationSettingsBase class, which offers methods like Load( ), to retrieve settings, and Save( ), to commit changes to the persisted store. In the .NET model, developers can attribute their code as in the example shown below ([UserSetting] attribute); during the process of reflection, the serialization of .NET classes into XML documents, these attributes are then captured and appear in the metadata section of the resultant manifest. The example below illustrates these concepts:

TABLE 13

// Define a Config Class - manifest metadata will be auto generated
// using reflection
[ConfigProvider(“WMI.Configuration”)]
class Settings: ApplicationSettingsBase {

[UserSetting]
public bool KeepWindowOnTop{

get { GetValue(KeepWindowOnTop) };
set { SetValue(KeepWindowOnTop, value};

}

}
Settings mySettings = new Settings( );
// Load the settings:
mySettings.Load( );
// read the value
bool onTop = mySettings.KeepWindowOnTop;
// set the value
mySettings.KeepWindowOnTop = false;
// commit changes
mySettings.Save( );

Manageability Scenarios

Management service(s) 260 can require more advanced functionality than simply loading and saving namespaces, reading and writing to settings and metadata, and registering for notifications on namespaces. Some management service(s) 260 can require the ability to query for settings with a certain attribute set to a particular value, within a namespace, or across several namespaces. An example of such a scenario is the Roaming service, which requires the ability to query settings for which the “Roam” attribute is set to “true”. Other management service(s) can require the capability to create assertions for a setting or group of settings within one or multiple namespaces; an example of such a service is Policy. Other services yet may need to import namespaces from or export them to portable XML documents; the Migration service and XCOPY are examples of such management service(s) 260. A service may require the capacity to retrieve change history, or to rollback transactions and revert a namespace back to a specific state; Backup/Restore requires such functionality. The API available via the configuration management engine 250 can provide the functionality required by these scenarios.

Query Scenarios

For management service(s) 260 such as Roaming, the configuration management engine 250 supports querying against settings and metadata within a namespace through the use of XPaths. To do so, an application can call the GetltemSet( ) method from within the SettingsNamespace instance. The GetltemSet( ) method takes as parameters a String branch, a ProcessingOptions object, and a Filter object. The branch identifies a path within the Virtual Document under which to conduct the query; specifically, the branch can specify whether the collection contains instance data or metadata. To retrieve instance data, the application calls the GetltemSet( ) method, specifying the branch as “/settings”; alternatively, to retrieve metadata, the application calls the GetltemSet( ) method with “/metadata” as the branch. Secondly, the GetltemSet( ) method accepts a ProcessingOptions object; this is an enumeration value, which can be used to describe whether or not to retrieve the default values of settings; whether to inherit values from parents; whether to remove escape characters from string values; etc. Finally, the Filter object is used to specify the XPath string that defines the query.

The GetltemSet( ) method returns an ItemCollection object, which is a container for the collection of entries returned by the query. The GetEnumerator( ) method called from the ItemCollection instance returns an Enumerator object that can be used to enumerate through all the elements in the collection The ItemCollection class also exposes an Item property, which can be used to retrieve a specific element of the collection by its index, or key; for settings, the key is a String representation of the settings name.

Using XPaths, queries can be conducted against attributes on complex types; names, values, and types of elements; as well as a whole range of query criteria. Multiple query criteria can be combined in single queries; the output of one query can be used as the input to another. The system 100 API (e.g., available via the configuration management engine 250 ) can expose the power and flexibility of XPath queries, of which applications and management service(s) 260 can take advantage.

Assertion Scenarios

Certain applications and management service(s) 260 may require the capacity to restrict the range of values that a setting can take; the mechanism provided by the system 100 API towards achieving this end is known as assertion. Group Policy is an example of a manageability service that needs this functionality. Group Policy is also responsible for handling all errors generated when it attempts to add policy to a system; such an error is generated when Policy tries to restrict the values of a particular setting, but the current value of the setting does not satisfy the restriction. The assertion mechanism provides a means for restoring an appropriate setting value in situations such as this. Group Policy may also want to associate the settings within specific users' contexts with a particular assertion. The developer of a user interface may be interested in enumerating the complete range of values allowed by an assertion. The aforementioned functionality requirements of Group Policy, in addition to many requirements of other management service(s) 260 can be supported by the assertion engine.

The majority of the functionality exposed by the assertions API can beencapsulated in the Metadata property inside the SettingsNamespace instance. This Metadata property, of type Metadata class, points to the metadata branch of the namespace. For example:

TABLE 14

// Declare a Metadata node object (metaNode)

Metadata metaNode = null;

// Point the metaNode to the Metadata property of the namespace

metaNode = appNamespace.Metadata;

In the example above, “appNamespace” is the name of the SettingsNamespace instance, and “metaNode” points to the Metadata property inside the SettingsNamespace instance; this step is a convenience for developers because much of the assertions API, exposed as methods inside this Metadata property, can now be accessed directly through “metaNode”.

In order to create a new assertion on a setting within a namespace, a call is made to the CreateAssertion( ) method within the Metadata property of that namespace (“metaNode” in our example). The CreateAssertion( ) method takes as parameters a String name, an AssertionType enumeration, a String expression, a String of satisfying values, and a Boolean representing pending initialization. The String name is a unique identifier for the assertion. The AssertionType enumeration specifies whether the assertion is developer-defined, administrator-defined, or administrator-created. The String expression uses the system 100 infrastructure assertion grammar to specify the settings affected by the assertion, as well as the manner in which they are affected; this expression is what must be satisfied in order for a setting value to pass the assertion. The String of satisfying values contains setting and value pairs that are used to replace the settings values affected by the assertion if those values don't pass the assertion; these satisfying values are only used at the time the assertion is initially applied to the setting. If the Boolean pending initialization is true, then the assertion is stored but not applied to the setting; otherwise, the assertion is applied. The code set forth in Table 15 declares parameter variables for the CreateAssertion( ) method:

TABLE 15
// Declare parameters for CreateAssertion( ) method

String assertionName=“OperationalAssertPlayers”;
AssertionType assertionType = AssertionType.OperationalAssertion;
String expression = “#/settings/players >= 10”;
String satisfyValues = “Value(#/settings/players , 10)”;
Boolean pending = false;

The API can provide the functionality for checking the validity of the assertion expression against a namespace. This is accomplished through a call to the IsAssertionExpressionValid( ) method within the Metadata property of that namespace. This operation should be performed, as a precaution, prior to the creation of an assertion, as illustrated below:

TABLE 16
// Declare an error result variable

ValidationResult errorResult=null;

// Check the validity of the expression syntax

errorResult = metaNode.IsAssertionExpressionValid(expression);

// If the expression syntax is valid, create an assertion

if (errorResult == null) // syntax correct
{

Assertion assertion = metaNode.CreateAssertion(assertionName,

assertionType,
expression,
satisfyValues,
pending);

}

The CreateAssertion( ) method returns an instance of an Assertion class. The Assertion class contains a variety of public properties and methods that specify additional information about the assertion. An example of a property is the String description, which can be used by the creator of the assertion to convey the purpose and intent of the assertion. An example of a method is the SetUsers( )method, which takes String[] array of users, and specifies that only settings within those users' contexts are affected by the assertion. The example below illustrates use of these members:

TABLE 17
// Define a description for the assertion

String assertionDescription = “Assertion applies to John Smith”;
assertion.Description = assertionDescription;

// Specify the affected users for the assertion

String[ ] affectedUsers = new String[1];
affectedUsers[0] = {“Redmond\JSmith”};
assertion.SetUsers(affectedUsers);

Import and Export Scenarios

The ability to export settings can be valuable for many scenarios; it allows the transformation of settings from an object model to a file format. Complimentarily, the ability to import allows the retrieval of such a file format, and a conversion of the settings back to the object model. This collective functionality offers portability of an application's settings between different environments. The Migration Service is an example of a manageability scenario that has a requirement for such functionality. Generally speaking, the act of Migration captures interesting settings and data for an application so that they may be applied to another machine. The Migration Service can use the export and import mechanisms provided by the system 100 API to transfer application settings between different machines.

The system 100 API can provide a mechanism for exporting an entire settings namespace into a portable XML document. The exported XML document contains the three branches of the settings namespace: the settings branch, which contains the instance values; the metadata branch, which contains the type definitions; and the transactions branch, which contains the settings'0 change history. The system 100 API can optionally import such a document and reconstruct the entire Virtual Document, or settings namespace.

In one example, the Export( ) method resides within the SettingsNamespace class, and can be called from within an instance of that class. The Export( ) method can write an XML document version of the settings namespace to a specified stream. The first parameter to the Export( ) method us the ExportOption enumeration, which defines constants that specify the sections of the manifest to export. The second parameter specifies the stream to which the exported manifest should be written.

The Import( ) method can also reside within the SettingsNamespace class, and can be called from within an instance of that class. The Import( ) method can read an exported XML document version of the settings namespace from a specified stream, and reconstruct the settings namespace. The first parameter to the Import( ) method us the ImportOption enumeration; similar to the ExportOption enumeration, it defines constants that specify the sections of the manifest to export. The second parameter specifies the stream from which the imported manifest should be read. Changing the structure of the namespace (e.g., types, adding elements etc.) is not permitted through Import( ) in this example. Only value changes including attribute values changes are permitted through Import( ). An assertion can also be added via Import ( ) in this example.

Transaction Scenarios

Some application(s) 240 and/or management service(s) 260 may be interested in retrieving or modifying the change history associated with a particular setting or namespace. Backup/Restore is an example of such a manageability service; this service requires the capability to revert to a prior settings state. For performance reasons, services may need to acquire a more specific change history; they may need to enumerate the settings that have changed since a particular timestamp. Applications and services might also be interested in querying for all transactions involving a particular setting. These scenarios can be achievable through the functionality exposed by the system 100 API.

Change history to the settings values are encapsulated within the Transactions container, exposed as a property inside the SettingsNamespace instance. This Transactions property, of type Transactions class, points to the transactions branch of the namespace. The sample below illustrates:

TABLE 18
// Declare a Transaction object

Transactions trnxnNode = null;

// Point the trnxnNode to the Transaction property of the namespace

trnxnNode = appNamespace.Transaction;

The Transactions object contains a LastTransaction property, which retrieves the identifier of the last transaction.

The Transactions class can also contain a Revert( ) method. This overloaded method can be called with no parameters; the effect is rolling back the last transaction that occurred in the SettingsNamespace instance. For a Revert( ) call to take permanent effect to the SettingsNamespace, a call must be made to the Save( ) method within the SettingsNamespace instance.

The act of calling the Save( ) method induces a transaction in the SettingsNamespace instance. By that reasoning, any call to the Revert( ) method that is followed by a Save( ) can be undone with a subsequent Revert( ). The example below illustrates:

TABLE 19

[ Save( ) Transaction A

Save( ) Transaction B
Save( ) Transaction C
Revert( ) @ Transaction B's State
Revert( ) @ Transaction A's State
Save( ) Transaction D (@ Transaction A's State)
Revert( ) @ Transaction C's State
Save( ) Transaction E (@ Transaction C's State)

]

The Revert( ) method can also be called with a RevertOption and a String transaction identifier. The RevertOption determines the transactions to revert. The String transaction identifier specifies which transaction to revert.

Authoring Scenarios

Some scenarios have requirements beyond touching and manipulating existing settings and metadata; applications in this category need to create new namespaces and define settings schema and metadata. Such scenarios fall in the class of authoring scenarios (e.g., via tool(s) which generate manifest(s) which are the compiled by the system 100 ). Such applications are required to create settings namespaces, and to define schemas and metadata for those namespaces. In order to define schemas for namespaces, these applications must be able define new complex types and simple types; additionally, they must also be able to declare elements and attributes. Furthermore, the ability to add metadata to the settings is a functionality requirement for the authoring space: registering assertions, substitutions, and custom handlers are desired capabilities in such scenarios.

To begin authoring a settings namespace, the application first instantiates an AdvancedSettingsEngine class; the AdvancedSettingsEngine object is then used to create a SettingsNamespace instance. This process is illustrated in the code sample shown below:

TABLE 20
// Allocate AdvancedSettingsEngine Object

AdvancedSettingsEngine engine = new AdvancedSettingsEngine( );

// Instantiate SettingsNamespace Object

SettingsNamespace newNamespace = engine.CreateNamespace( );

After having created a new SettingsNamespace object, the next logical step is to define attributes on that namespace as a whole. The effect of such an action is to define general metadata for the entire namespace. To accomplish this, a call is made to the AddAttribute( ) method from within the SettingsNamespace instance. Adding attributes to the settings namespace is demonstrated by the following example:

TABLE 21
// Add all the attributes allowed on namespace level

newNamespace.AddAttribute(“context”, “perUser”);
newNamespace.AddAttribute(“accessControl”, “invalid ACL”);
newNamespace.AddAttribute(“atomic”, “false”);
newNamespace.AddAttribute(“roam”, “false”);
newNamespace.AddAttribute(“migration”, true);
newNamespace.AddAttribute(“backup”, “true”);

Much like a manifest author might include a namespace declaration in order to utilize predefined types, the Authoring API allows importing shared types from a manifest file. The first step towards accomplishing this goal is to read the manifest file into a stream; this is followed by a call to the Import( ) method from within the SettingsNamespace instance. The “ImportOption.ImportManifestFormat” and “ImportOption.ImportMetadata” flags should be passed to the Import( ) method in order to accomplish the desired functionality:

TABLE 22

// Declare a Metadata object to point to our namespace's Metadata

Metadata metadata = newNamespace.Metadata;

// Declare a FileStream

FileStream manifestStream;

// Open a FileStream to read the manifest for shared types

manifestStream = File.Open(“wcmtypes.man”,

FileMode.Open,
FileAccess.Read,
FileShare.None);

// Read in the manifest for shared types

newNamespace.Import(ImportOption.ImportManifestFormat |

ImportOption.ImportMetadata, manifestStream);

SimpleTypes

One of the actions allowed in the creation of a manifest is the definition of a simple type; thus, this functionality is mirrored by the Authoring API. Custom simple types can be created by allocating a SimpleType object. The constructor of the SimpleType class takes as a parameter the SettingsNamespace instance to which it will belong. Properties of the SimpleType class, such as Name and Type, map to the analogous attributes on a <simpleType> element in a manifest document. In order to infuse the newly defined SimpleType object into our namespace, the application calls the Add( ) method in the SimpleTypes property of the MetaData branch within the SettingsNamespace instance, as per the example below:

TABLE 23

// Declare SimpleType object

SimpleType newSimpleType;

// Add simple type definition for “Colortype”

newSimpleType = new SimpleType(newNamespace);
newSimpleType.Name = “ColorType”;
newSimpleType.Type = “xsd:string”;
metadata.SimpleTypes.Add(newSimpleType);

The simple type can be further differentiated through the introduction of a restriction. A restriction is a set of boundaries, known a “facets”, which constrain the range of values to which a simple type can map; this construct maps to a restriction subelement within a <simpleType> element in the manifest document. One type of facet defined by the Authoring API is an “enumeration”: this facet-type allows for a simple type to map to a defined set of values. The enumeration facet maps to an enumeration subelement of a restriction element in the manifest document. In order to create an enumeration restriction facet, a call is made to the Create( ) method in the Restriction property of the SimpleType instance, passing the String “enumeration” as the only parameter. The Create( ) method returns an instance of the Metadataltem class, the Value property of which can be set to an array containing the members of the enumeration set. The example below illustrates the process of restricting a simple type by an enumeration facet:

TABLE 24

// Declare MetadataItem object

MetadataItem newRestrictionFacet;

// Add enumeration restriction to the simple type

newRestrictionFacet = (MetadataItem )

newSimpleType.Restrictions.Create(“enumeration”);

// Define the enum values

String[ ] enumValuesColor = {“BLUE”, “RED”, “GREEN”};
newRestrictionFacet.Value = enumValuesColor;

Another means to which facets can be used to restrict a simple type is the introduction of a (“minlnclusive”, “maxinclusive”) pair. These facets are reserved for restricting simple types with integer bases. The effect is that the range of the restricted simple type must be in between the “minlnclusive” and “maxinclusive” values, inclusive. The example below illustrates the restriction of an integer-based simple type by these facets:

TABLE 25

// Add simple type definition for “RangeType”

newSimpleType = new SimpleType (newNamespace);
newSimpleType.Name = “RangeType”;
newSimpleType.Type = “xsd:int”;

// Add mininclusive restriction facet to the simple type

newRestrictionFacet = (MetadataItem )

newSimpleType.Restrictions.Create (“minInclusive”);

newRestrictionFacet.Value = “1”;

// Add maxinclusive restriction facet to the simple type

newRestrictionFacet = (MetadataItem )

newSimpleType.Restrictions.Create (“maxInclusive”);

newRestrictionFacet.Value = “100”;

// Add simple type definition for “Colortype”

metadata.SimpleTypes.Add(newSimpleType);

In the example above, the simple type defined as a “RangeType” must carry an integer value between 1 and 100, inclusive. An attempt to populate an instance of this type with a value outside of this range will violate the restriction and generate an exception.

Complex Types

Unlike simple types, complex types allow elements in their content and can carry attributes, adding another dimension to the space of types spanned by the system 100 infrastructure manifest schema. Again, this functionality is mirrored by the Authoring API. Complex types are created by allocating a ComplexType object. The constructor of the ComplexType class takes as a parameter the SettingsNamespace instance to which it will belong. One property of the ComplexType class is its Name, which maps to the parallel attribute on a <complexType> element in a manifest document; other properties include DisplayName and Description, which are API specific constructs. Observe the sample below:

TABLE 26
// Declare a ComplexType object

ComplexType newComplexType;

// Add complex type definition for “PointType”

newComplexType = new ComplexType(newNamespace);
newComplexType.Name = “PointType”;
newComplexType.DisplayName = “DisplayName of PointType”;
newComplexType.Description = “Description of PointType”;

After having created the ComplexType object, the next step is to build the type by adding member elements. The first step towards achieving this is allocating a Member object. The constructor of the Member class takes as a parameter the SettingsNamespace instance to which it will belong. Properties of the Member class include Name, Type, and DefaultValue, which map to analogous attributes on a <element> element in a manifest document. Other properties, such as DisplayName and Description, are API specific constructs. Once these properties are set, a call is made to the Add( ) method in the Children property of the ComplexType instance. The example below illustrates:

TABLE 27

// Declare a ComplexType object

Member newMember;

// Add an “xcoord” element to the “PointType” ComplexType

newMember = new Member(newNamespace);
newMember.Name = “xcoord”;
newMember.Type = “xsd:integer”;
newMember.DisplayName = “Displayname of xcoord”;
newMember.Description = “Description of xcoord”;
newMember.DefaultValue = “11”;
newComplexType.Children.Add(newMember);

// Add a “ycoord” element to the “PointType” ComplexType

newMember = new Member(newNamespace);
newMember.Name = “ycoord”;
newMember.Type = “xsd:integer”;
newMember.DisplayName = “DisplayName of ycoord”;
newMember.Description = “Description of ycoord”;
newMember.DefaultValue = “22”;
newComplexType.Children.Add(newMember);

The code sample above is for the creation of a “PointType” complex type, which contains two integer elements: an x-coordinate, and a y-coordinate. Generally, there is no limit on the number of elements that can be contained within a complex type. Members can be removed by a call to the Remove( ) method in the Children property of the ComplexType instance, as shown in the example below:

// Remove an element from the ComplexType

newComplexType.Children.Remove(newMember.Name);

Finally, the ComplexType object is added to the namespace; to do this, the application calls the Add( ) method in the ComplexTypes property of the MetaData branch within the SettingsNamespace instance, as per the example below:

// Add this complex type definition

metadata.ComplexTypes.Add(newComplexType);

Complex types can be nested within each other; in other words, a can declare a member to be of some complex type, such as the “PointType” complex type shown above, and add that member to another complex type. Generally, there is no restriction on the depth of nested complex types. The example below shows how complex types can be nested:

TABLE 28
// Add complex type definition for “WindowType”, which contains
// two member elements, each of complex type

newComplexType = new ComplexType(newNamespace);
newComplexType.Name = “WindowType”;
newComplexType.DisplayName = “DisplayName of WindowType”;
newComplexType.Description = “Description of WindowType”;

// Add a “topLeft” element of type “PointType” to the ComplexType

newMember = new Member(newNamespace);
newMember.Name = “topLeft”;
newMember.Type = “PointType”;
newMember.AddAttribute(“key”, “xcoord ycoord”);
newComplexType.Children.Add(newMember);

// Add a “bottomRight” element of type “PointType” to the ComplexType

newMember = new Member(newNamespace);
newMember.Name = “bottomRight”;
newMember.Type = “PointType”;
newComplexType.Children.Add(newMember);

// Add this complex type definition

metadata.ComplexTypes.Add(newComplexType);

Complex types themselves can also be removed from a settings namespace while the namespace is open for authoring. To do this, the application calls the Remove( ) method in the ComplexTypes property of the MetaData branch within the SettingsNamespace instance, as per the example below:

// Add this complex type definition

metadata.ComplexTypes.Remove(newComplexType.Name);

Elements

Elements are the final ingredients of the application manifest schema; naturally, the Authoring API exposes a mechanism for declaring elements. Elements define the actual settings that the application consumes; they can be created by allocating an Element object. The constructor of the Element class takes as a parameter the SettingsNamespace instance to which it will belong. Properties of the Element class, such as Name and Type, map to the analogous attributes on an <element> element in a manifest document. Other properties that can be set, such as DisplayName and Description, are API specific constructs. Furthermore, custom attributes can be added to the Element instance by calling the AddAttribute method from within the Element instance. Attribute values defined on the Element instance will override any globally defined attributes on the SettingsNamespace instance. In order to add the element to the namespace, the application calls the Add( ) method in the Elements property of the MetaData branch within the SettingsNamespace instance, as shown by the example below:

TABLE 29
// Add setting instance of type “PointType”
// Declare a new Element

newElement = new Element(newNamespace);
newElement.Name = “windowPosition”;
newElement.Type = “PointType”;
newElement.DisplayName = “DisplayName of windowPosition”;
newElement.Description = “Description of windowPosition”;

// Add attributes to the element

newElement.AddAttribute(“handler”, “regkey(′HKCU\\MyApp′)”);
newElement.AddAttribute(“privacy”, false);
newElement.AddAttribute(“accessControl”, “something here”);
newElement.AddAttribute(“adminConfig”, true);

// Add the element to the settings namespace

metadata.Elements.Add(newElement);

Similarly to previous examples, elements themselves can also be removed from a settings namespace while the namespace is open for authoring. To do this, the application calls the Remove( ) method in the Elements property of the MetaData branch within the SettingsNamespace instance:

// Remove the element from the settings namespace

metadata.Elements.Remove(newElement.Name);

In order to create an element of a XML Schema base type, the specified type of that element must be prefixed by the namespace containing the XML Schema Definitions themselves. For example, if the application wanted to create a setting element of type float, it would follow similar steps to these:

TABLE 30

// Create a setting of float-point number

newElement = new Element(newNamespace);
newElement.Name = “floatSetting”;
newElement.Type = “xsd:float”;
newElement.AddAttribute(“default”, “1.1”);

// Add the element to the settings namespace

metadata.Elements.Add(newElement);

Exporting and Saving

Upon completion, the namespace can be exported to a manifest document, or it can be saved and registered with the configuration service component 110. In this example, first a Namespaceldentity is created, with the namespace's name, version, culture, and context; the Identity property inside the SettingsNamespace must be made to point to Namespaceldentity instance:

TABLE 31

// Declare the namespace identity

NamespaceIdentity namespaceID;

// Specify the namespace identity

namespaceID = new NamespaceIdentity(

“http://www.microsoft.com/state/WcmAuthor”,
“1.0.0.0”,
“en-US”,
null);

newNamespace.Identity = namespaceID;

In order to export the manifest, the application opens a stream for writing, and then exports the manifest to that stream with the “ExportOption.ExportMetadata” flag, as illustrated below:

TABLE 32

// Open a FileStream to write the manifest

manifestStream = File.Open(OutputFileName,

FileMode.CreateNew,
FileAccess.ReadWrite,
FileShare.None);

// Write out the manifest

newNamespace.Export(ExportOption.ExportMetadata,
manifestStream);
manifestStream.Close( );

In order to register the manifest, a simple call is made to the Save method within the SettingsNamespace instance.

Thus, in this example, despite a seemingly large and diverse scenario space for functionality requirements of the system 100, there exists a comprehensive solution in the system 100 API that spans the aforementioned space. Many scenarios can be solved through combining pieces of the functionality discussed this example. For example, a certain scenario has a requirement for keeping track of all the setting across the entire system for which notifications have been registered. This scenario can be solved by enumerating the namespaces, querying each namespace for which there are non-null notification handler attributes, and combining the results. Many such seemingly-complex scenarios can be solved in similar combinatorial manners. The API's ease of use renders it an advantageous option for settings access: it is a clear window into the system's configuration.

Compatibility and Transition

As discussed, optionally, the system 100 can facilitate configuration management for legacy application(s). For application developers, the advantages of moving to the system 100 managed configuration store are numerous: for their settings, applications reap the benefits of role-based security, transactional processing and atomicity, consistency, integrity enforcement, isolation, tracking, durability, and recoverability, among several other promising returns. However, the nature of the settings management problem space is such that no solitary, all-encompassing solution can completely and harmoniously span each and every scenario in that problem space. Therefore, there can be a need to maintain the legacy stores of old to cover such clamorous and nonconforming scenarios (e.g., registry 294 and/or INI file(s) 290 ).

Some applications have evolved very highly-tuned settings stores over the years which offer them specific performance enhancements or organizational advantages. Other applications are inclined to maintain their legacy settings stores for reasons of interoperability and backwards compatibility. The existence of multiple proprietary formats for settings storage introduces an order of complexity into the problem of settings discoverability: management service(s) 260 must have intimate knowledge of each esoteric settings store in order to tailor their services to every component's needs. Furthermore, every additional cryptic settings store diffuses the system's uniformity of settings semantics.

For such components with strong attachments to their legacy stores, a clear path to discoverability lies in the manifest; components can also bring an enhanced precision in the meaning of their settings through the uniform settings semantics constrained by the manifest. In order to attain the desired echelons of discoverability and semantics, applications can submit a configuration manifest with appropriate decorations of types, descriptions, and manageability attributes for their settings, all the while preserving their settings values in their proprietary stores. The effect of such a level of interaction with the system 100 is two copies of the setting: one for long-established settings access, in the legacy store; and one for the promotion of discoverability and semantics, in the system store 120.

Legacy and Dynamic Settings

This section describes the different levels of integration applications can have with the system 100 infrastructure configuration system and their benefits. Examples of how to use system 100 infrastructure while maintaining settings in legacy stores are shown.

In one example, “level 1 integration”, applications are strongly encouraged to use the system 100 to both store and access their settings. This level of integration provides the richest benefits of the system 100 infrastructure-app configuration is discoverable and manageable, and configuration validity can be ensured.

However, for reasons discussed previously, some applications may want to continue storing settings in the registry 294, INI file(s) 290, and/or other legacy stores, such as the IIS Metabase. These applications can either access the legacy settings using the system 100 API through the Level 1 Integration model; or they may directly access the legacy stores themselves using legacy API—“level 0 integration”. The latter level of integration provides partial benefits—application configuration is discoverable and manageable; but, configuration validity and consistency cannot ensured, because the system 100 has no control over legacy stores where the validity of settings could be compromised.

On the other end, there may be applications that don't provide a manifest at all—level-1 integration. This non-integration obviously provides none of the desirable benefits—application configuration is not well known or discoverable.

For applications with Level 0 integration, the system 100 provides a way to tie settings described in the manifest to legacy locations where they are ultimately stored. Such settings need to be associated with a legacy handler 220 that implements the get/set access methods in the legacy store.

In one example, the system 100 provides built- inbuilt legacy handlers 220 for settings stored in the registry 294 and INI file(s) 290. For other stores, the manifest author provides a COM-registered handler to implement a common handler interface, which includes the get/set methods. Settings values in the configuration store 120 and the legacy stores are kept in sync by a process called Legacy Synchronization. The system 100 performs the legacy sync operation periodically, and on reads from and writes to settings via the system 100 API.

Legacy Settings in the Registry

To associate a setting to a registry key or value, it can be marked with wcm:handler and wcm:legacyName attributes, for example:

TABLE 33

<metadata>

<elements>

<MySampleValue wcm:default=″0″

wcm:legacyType=″REG_DWORD″
wcm:handler=″regkey(′HKEY_CURRENT_USER\Software\Microsoft\WCMSample′)″

wcm:legacyName = “SampleValue” />

</elements>

</metadata>

The example of Table 32 indicates that the physical location of the value MySampleValue is not in the configuration store 120, but a registry key. When a client application commits changes to this value to the system 100 via the API, the value will ultimately get written to the registry 294. Similarly, changes to the value directly in the registry will be reflected in the configuration store 120 after legacy sync.

Legacy Settings in an INI file

To associate a setting to an entry in an INI file, the wcm:Handler attribute can specify the full path name of the INI file, for example:

TABLE 34
<wcm:metadata>

<wcm:elements>

<MyKeyName wcm:handler=“ini(′c:\ini\iniTst.ini[TstSection]′)”

wcm:legacyName=“KeyName”/>
</wcm:elements>

</wcm:metadata>

Legacy Settings in a Custom Store

To associate a setting with a custom handler, the manifest first defines the custom handler, for example:

TABLE 35

<wcm:metadata>

<wcm:customHandlers>

<wcm:customHandler name=“myHandler”
handlerType=“COM”

handlerSource=“CLSID”/>

</wcm:customHandlers>
<wcm:elements>

<myValue wcm:handler=“myHandler”/>

</wcm:elements>

</wcm:metadata>

Optional Legacy Applications

As discussed previously, the system 100 can, optionally, store configuration information for legacy application(s).

Abstracting Up: Refactored Settings

A related concept to the above section on factoring data vs. configuration lies in the overall simplicity of the items finally placed in the settings manifest.

While an application may have a large number of settings, if these are not logically grouped into higher level abstractions, they can present administrators with a manageability challenge. A multitude of individual items are often confusing to configure, and changes can also very difficult to trace via a diagnostics tool. Quite often they also have implicit dependencies that may render certain combinations of setting values invalid. The solution to this problem lies in the Refactored Setting.

To better understand refactored settings, consider using a few high-level settings (e.g. SECURITY LEVEL=HIGH or LOW or MEDIUM) can actually present the administrator with a far cleaner and more manageable model. In this example updating the SECURITY LEVEL setting can actually force a number of smaller settings items to a mutually consistent set of new values. A diagnostics trace on the SECURITY LEVEL change is also far more comprehensible than tracing through the multiple individual settings changes that may otherwise be difficult to correlate

Utilities

Tools

Various tool(s) can be employed to create the manifest files, register them with the system 100 and/or edit settings or metadata stored in the configuration store 120.

Manifest Authoring

A GUI tool can be employed to facilitate authoring of the manifest. The GUI tool can support creation of custom types, importing settings from the registry 294 and/or validation of the manifest.

In one example, a command line tool can be employed to create a manifest from a set of registry key(s). The tool can review the names and types of settings in the registry 294 and generate XSD types and element names. The tool can further use the values in the registry 294 to generate default values.

Manifest Registration

The manifest can be registered with the system 100 before invocation of APIs on the namespace. This can be accomplished, for exampled, via a command line tool.

Viewing/Editing the Configuration Store 120

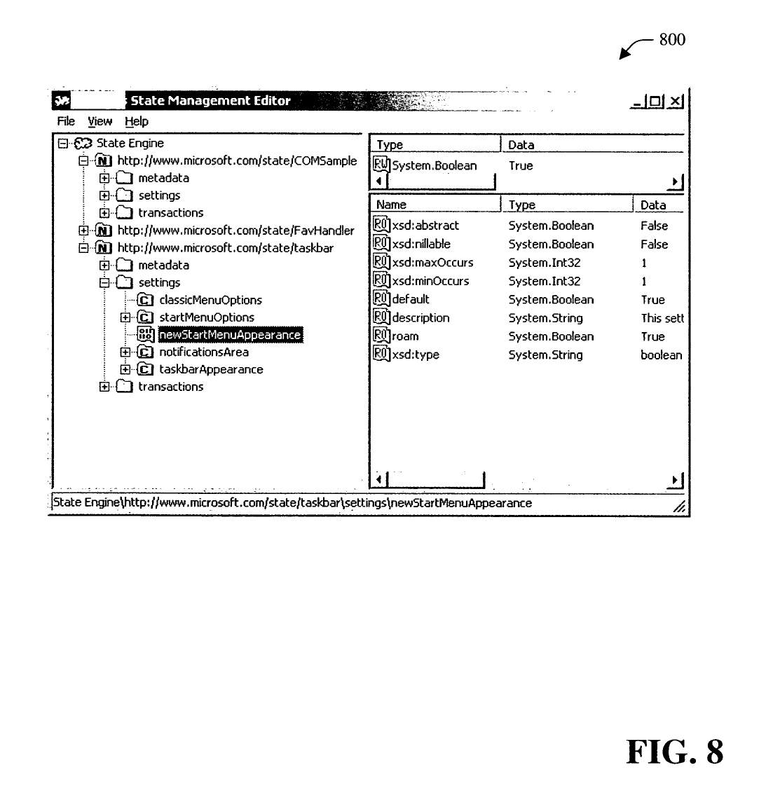

Once a manifest is registered, an editing tool can facilitate viewing and/or manipulation of metadata and/or setup in the manifest. Turning briefly to FIG. 8, an exemplary graphic user interface tool 800 in accordance with an aspect of the present invention is illustrated. For example, the tool 800 can facilitate manipulation of settings in a registered manifest. The tool can be used to:
View current value, metadata or change history of settings.
Edit current value or metadata of settings.
Export settings into an XML file.
Import settings from an XML file.

Each manifest registers one namespace with the system 100. The settings in the manifest belong to this namespace. The tool 800 each of the registered namespaces and the values and metadata of associated settings. In the tool 800, each namespace is divided into three sections, like the virtual XML document view presented to client applications by the system 100 API:
Metadata
Settings
Transactions

The metadata node contains information about the type of a setting, its default value, validation rules etc. The settings node contains the current values of each setting transactions node lists the history of changes done to this namespace.

On the right hand side of the tool 800, there is a top and bottom pane. The top pane lists the current value. The bottom pane describes the metadata of the setting.

A settings value can be changed by choosing a setting in the settings node and modifying its value in the right top pane. The metadata can be modified by choosing the metadata in the metadata node and modifying its value in the right bottom pane.

Once the modifications have been made, they can be committed in order for the configuration store 120 to reflect the modifications. In this example, the changes in a namespace can be committed by right clicking the namespace in the left pane and choosing the Commit option. The committed transaction will show up in the transactions node. In this example, the view is then refreshed to view the new transactions.

The settings in a namespace can be exported into an XML format, by right clicking the namespace in the left pane and choosing the Export Namespace Settings option. Similarly settings can be imported from an XML file by choosing the Import Namespace Settings option.

Enabling Tracing

The system 100 can employ a software tracing mechanism to generate trace log(s).

It is to be appreciated that the system 100, configuration service component 110, the configuration store 120, the assertion engine 210, the legacy handler(s) 220, the configuration shared memory 230, the client application 240, the configuration management engine 250, the management service(s) 260, the group policy component 270, the roaming component 280, the INI file(s) 290, the registry 294, the architecture 300, the architecture 400, the Virtual Document Layer representation 500, the architecture 600, architecture 700 and/or the tool 800 can be computer components as that term is defined herein.

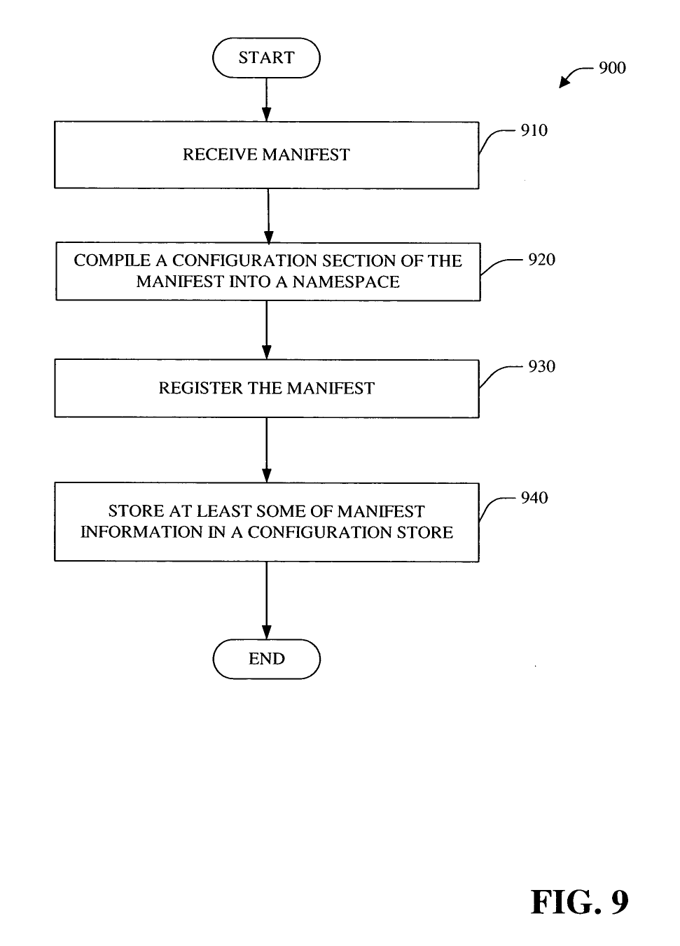

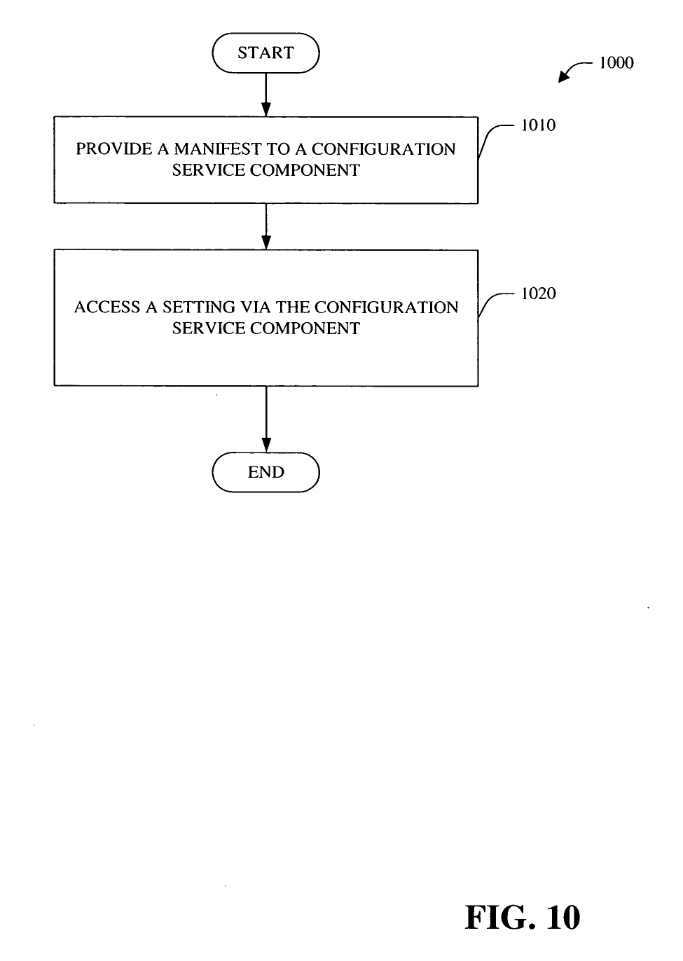

Turning briefly to FIGS. 9 and 10, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 9, a method facilitating configuration management 900 in accordance with an aspect of the present invention is illustrated. At 910, a manifest is received (e.g., from an application 240). At 920, a configuration section of the manifest is compiled into a namespace. At 920, the manifest is registered (e.g., by the configuration service component 110). At 930, at least some of the manifest information is stored in a configuration store (e.g., configuration store 120).

Turning to FIG. 10, a method facilitating configuration management 1000 in accordance with an aspect of the present invention is illustrated. At 1010, a manifest is provided to a configuration service component (e.g., configuration service component 110). At 1020, a setting of an application is accessed via the configuration service component (e.g., configuration service component 110).

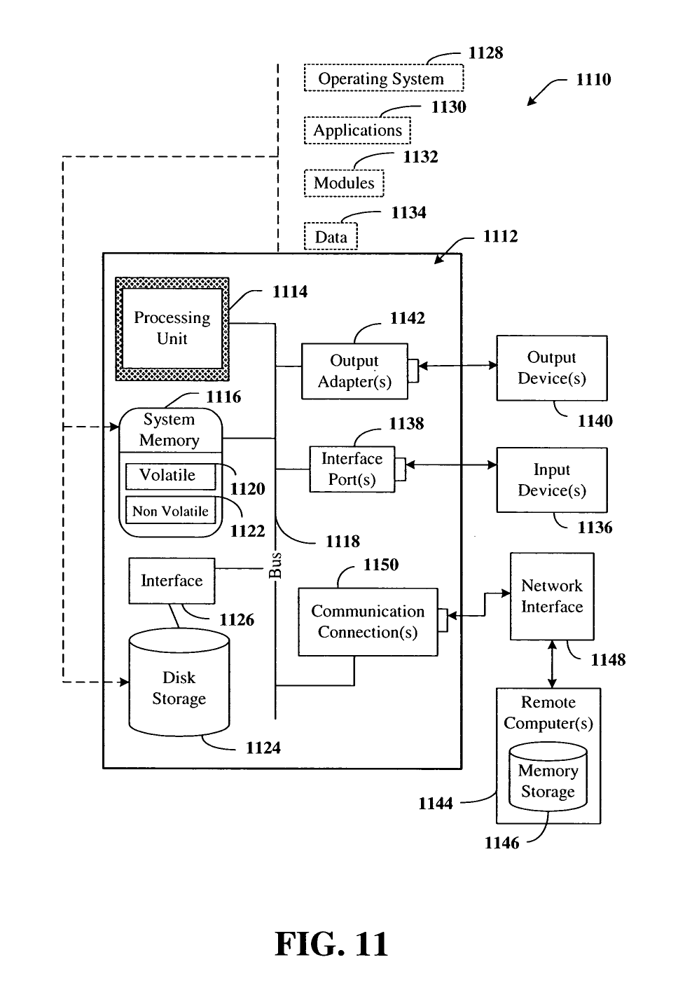

In order to provide additional context for various aspects of the present invention, FIG. 11 and the following discussion are intended to provide a brief, general description of a suitable operating environment 1110 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 1110 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 11, an exemplary environment 1110 for implementing various aspects of the invention includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/nonremovable, volatile/nonvolatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the present invention can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1 144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/EEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A configuration management system comprising:
a configuration store that stores persisted information associated with an application, the persisted information comprising at least one of configuration and dependency information; and,
a configuration service component that manages access to the configuration store.

2. The system of claim 1, wherein the configuration service component receives a manifest associated with the application, the manifest comprising at least one of configuration and dependency information associated with the application, and the configuration service component stores at least some of the manifest information in the configuration store.

3. The system of claim 2, wherein the manifest is based, at least in part, upon a schema.

4. The system of claim 3, wherein the schema is XML-based.

5. The system of claim 2, wherein the manifest employing at least one of strong typing, validation, and assertions.

6. The system of claim 2, wherein the configuration service component compiles at least one of manifest information into a namespace, the configuration service component providing access to the namespace.

7. The system of claim 1, further comprising a configuration management engine that facilitates management of at least some of the configuration information.

8. The system of claim 1, the configuration service component facilitating access to a legacy store.

9. The system of claim 8, the legacy store comprising at least one of a registry and an INI configuration file.

10. The system of claim 1, the configuration service component facilitating at least one management service.

11. The system of claim 10, the management service comprising at least one of a group policy component and a roaming component.

12. The system of claim 10, the management service facilitating at least one of install, usage, servicing, uninstall, roaming, migration, setup, provisioning, policy, backup and/or restore.

13. The system of claim 1, further comprising an assertion engine that facilitates administration of a validation rule by the configuration service component.

14. The system of claim 1, further comprising a notification handler that provides information associated with a configuration change of the application to at least one of the application and another application.

15. The system of claim 1, further comprising a legacy handler that facilitates synchronization of the system with a legacy store.

16. The system of claim 1, wherein the configuration service component facilitates transacted commits for saving related changes together in the configuration store.

17. The system of claim 1, wherein the configuration service component employs at least one of ACL-based security and role-based security are provided at per-setting granularity.

18. The system of claim 1, wherein the configuration service component facilitates change logs and history.

19. An application program interface that facilitates communication with the system of claim 1.

20. The application program interface of claim 19, the application program interface facilitating at least one of discovery of an application's setting and modification of an application's setting.

21. The application program interface of claim 19, wherein the application program interface facilitates at least one of loading a namespace, saving a namespace, enumerating a namespace, consuming a setting value, enumerating a setting value, consuming metadata, enumerating metadata, querying, reverting a transaction, creating and merging an integrity constraint in the form of an assertion, registering for a change notification, and authoring a settings namespace.

22. A management service that employs an application program interface, wherein the application program interface facilitates communication with the system of claim 1.

23. The system of claim 1, wherein the configuration store comprises a joint engine technology database that stores a settings namespace.

24. The system of claim 23, wherein a namespace comprises metadata on the settings comprising types, attributes, and user context, the namespace further comprising an instance values of the settings,

25. The system of claim 24, wherein at least one of the metadata on the setting and instance values of the settings is stored for each user context.

26. The system of claim 1, wherein at least one of URI and Xpath can access a setting within a namespace as well as in between namespaces.

27. A configuration management system comprising:
a local cache that at least temporarily stores changes to configuration information associated with an application; and,
a configuration engine that facilitates communication of the changed configuration information stored in the local cache to a configuration service component.

28. A method for facilitating configuration management comprising:
receiving a manifest associated with an application, the manifest comprising at least one of configuration and dependency information;
registering the manifest; and,
storing at least some of the manifest information in a configuration store.

29. The method of claim 28, further comprising compiling a configuration section of the manifest into a namespace.

30. A computer readable medium having stored thereon computer executable instructions for carrying out the method of claim 28.

31. A method of facilitating configuration management comprising:
providing a manifest, the manifest associated with at least one of configuration and dependency information of a first application; and, accessing a setting of an application via a configuration service component.

32. The method of claim 31 further comprising at least one of the following acts:
identifying settings in a namespace associated with the first application;
defining a name, a type, a description and default value for a setting;
defining other metadata for the setting;
providing a validation rule for the setting;
indicating service applicability for the setting; and,
identifying a dependency using an assertion expression.

33. The method of claim 32, further comprising at least one of the following acts:
accessing a setting associated with the first application; and,
accessing a setting associated with a second application.

34. A computer readable medium having stored thereon computer executable instructions for carrying out the method of claim 32.

35. A data packet transmitted between two or more computer components that facilitates configuration management, the data packet comprising:
a configuration manifest comprising a schema section and a metadata section, the schema section comprising an XML Schema Definitions Language (XSDL) document the skeletal structure of an application's settings' type definitions and element declarations, and, the metadata section comprising an XML instance document, validated against the XSDL schema document, which serves to decorate the settings elements with attribute tags, and to facilitate integrity constraints.

36. The data packet of claim 35, the schema section comprising at least one of a simple type, a restriction of a system's built-in scalar type, a complex type, and, a structure that can contain element content.

37. The data packet of claim 35, the configuration manifest further comprising at least one of a default, a description, a context, an access control, a validation, an exposure to manageability services and other state-related information.

38. A computer readable medium storing computer executable components of a configuration management system comprising:
a configuration service component that manages access to a configuration store, the configuration service component comprising an assertion engine component and a legacy handler component, wherein the configuration store stores persisted configuration information associated with an application.

39. A configuration management system comprising:
means for storing configuration information associated with an application; and,
means for managing access to the means for storing configuration information.
